(19) United States
(12) Patent Application Publication
(10) Pub. No.: US 2025/0056405 A1
(43) Pub. Date: Feb. 13, 2025

(54) DISCONTINUOUS COMMUNICATION CYCLE CONFIGURATION SWITCHING

(71) Applicant: QUALCOMM Incorporated, San Diego, CA (US)

(72) Inventors: Ahmed ELSHAFIE, San Diego, CA (US); Huilin XU, Temecula, CA (US); Linhai HE, San Diego, CA (US)

(21) Appl. No.: 18/446,372

(22) Filed: Aug. 8, 2023

(51) Int. Cl. H04W 52/02; H04W 76/28

(52) U.S. Cl. CPC H04W 52/0216; H04W 76/28

(57) ABSTRACT

Methods, systems, and devices for wireless communications are described. A user equipment (UE) and/or a network entity may support communicating according to a discontinuous communication cycle, such as a discontinuous reception (DRX) cycle or a discontinuous transmission (DTX) cycle. A network entity may configure a UE with multiple sets of parameters for one or more types of discontinuous communication cycles, such as by indicating multiple sets of parameters for a first type of discontinuous communication cycle, multiple sets of parameters for a second type of discontinuous communication cycle, or both. The UE and the network entity may communicate according to a first discontinuous communication cycle associated with a first set of the multiple set of parameters. Based on identifying a trigger condition, the UE and the network entity may switch to communicate according to a second discontinuous communication cycle associated with a second set of the multiple set of parameters.

### FIELD OF TECHNOLOGY

The following relates to wireless communications, including discontinuous communication cycle configuration switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A communication device may support communicating according to a discontinuous communication cycle. Updating or indicating new cycle configurations may be associated with relatively long latency.

### SUMMARY

The described techniques relate to improved methods, systems, devices, and apparatuses that support discontinuous communication cycle configuration switching. For example, the described techniques provide for reduced latency associated with switching between discontinuous communication cycle (e.g., discontinuous reception (DRX), discontinuous transmission (DTX)) configurations, for example, by configuring multiple sets of parameters between which a communication device (e.g., a user equipment (UE), a network entity) may switch, such as without the communication of signaling to update or indicate a new cycle configuration. For instance, a network entity and a UE may communicate according to various types of discontinuous communication cycles, such as a long discontinuous communication cycle and/or a short discontinuous communication cycle. The network entity may indicate multiple sets of parameters for one or more of the types of discontinuous communication cycles to the UE (e.g., multiple sets of parameters for a long discontinuous communication cycle, multiple sets of parameters for a short discontinuous communication cycle), and the network entity and/or the UE may switch between communicating according to different discontinuous communication cycles in accordance with corresponding sets of the multiple sets of parameters indicated. The network entity and/or the UE may perform the switch based on a trigger condition, such as one or more messages communicated between the network entity and the UE that result in the switch.

A method for wireless communications by a UE is described. The method may include receiving control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle, communicating according to a first discontinuous communication cycle of the first type or the second type in accordance with a first set of parameters of the set of multiple sets of parameters, and communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

A UE for wireless communications is described. The UE may include one or more memories storing processor executable code, and one or more processors coupled with the one or more memories. The one or more processors may individually or collectively operable to execute the code to cause the UE to receive control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle, communicating accord to a first discontinuous communication cycle of the first type or the second type in accordance with a first set of parameters of the set of multiple sets of parameters, and communicating accord to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

Another UE for wireless communications is described. The UE may include means for receiving control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle, means for communicating according to a first discontinuous communication cycle of the first type or the second type in accordance with a first set of parameters of the set of multiple sets of parameters, and means for communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

A non-transitory computer-readable medium storing code for wireless communications is described. The code may include instructions executable by a processor to receive control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle, communicating accord to a first discontinuous communication cycle of the first type or the second type in accordance with a first set of parameters of the set of multiple sets of parameters, and communicating accord to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

Some examples of the method, UEs, and non-transitory computer-readable medium described herein may further include operations, features, means, or instructions for communicating an indication associated with switching between discontinuous communication cycles, where the trigger condition corresponds to the communication of the indication.

In some examples of the method, UEs, and non-transitory computer-readable medium described herein, the indication includes an indication from the UE to switch to the second discontinuous communication cycle, an indication from a network entity to switch to the second discontinuous communication cycle, an end of burst indication from the UE, an end of burst indication from the network entity, a physical downlink control channel (PDCCH) skipping indication from the network entity, a DRX medium access control-control element (MAC-CE), an indication of a change of traffic from the network entity, one or more scheduling requests from the UE, one or more NACKs from the UE, one or more NACKs from the network entity, a buffer status report (BSR), an indication of XR traffic, a delay status report (DSR), a statistical delay report (SDR), or an energy report.

In some examples of the method, UEs, and non-transitory computer-readable medium described herein, the switch to the second discontinuous communication cycle may be based on a quantity of data associated with the BSR, an uplink packet data convergence protocol queueing delay associated with the DSR, an uplink packet data convergence protocol queueing delay associated with the SDR, a remaining packet delay budget indicated by the DSR for one or more logical channels (LCHs) or LCH groups (LCGs), a remaining packet delay budget indicated by the SDR for the one or more LCHs or LCGs, a charging rate indicated by the energy report, a discharging rate indicated by the energy report, an energy level associated with the UE indicated by the energy report, or an energy level prediction associated with the UE based on the energy report.

Some examples of the method, UEs, and non-transitory computer-readable medium described herein may further include operations, features, means, or instructions for transmitting a request to switch from the first discontinuous communication cycle to the second discontinuous communication cycle, where the trigger condition corresponds to the transmission of the request.

In some examples of the method, UEs, and non-transitory computer-readable medium described herein, transmitting the request may include operations, features, means, or instructions for transmitting the request via UCI, a MAC-CE, RRCsignaling, or a combination thereof.

In some examples of the method, UEs, and non-transitory computer-readable medium described herein, transmitting the request may include operations, features, means, or instructions for multiplexing the request with a message including a scheduling request, a hybrid automatic repeat request (HARQ) message, an uplink reference signal, a BSR, a power headroom report (PHR), a channel state information (CSI) report, or a combination thereof and transmitting the request multiplexed with the message.

In some examples of the method, UEs, and non-transitory computer-readable medium described herein, the request may be communicated based on one or more communication conditions satisfying one or more thresholds, the one or more communication conditions including a buffer status associated with a BSR, a delay status associated with a DSR, an error status associated with an error status report, a traffic condition, or a combination thereof.

Some examples of the method, UEs, and non-transitory computer-readable medium described herein may further include operations, features, means, or instructions for communicating an energy report indicating a first energy level associated with the UE or a second energy level associated with a network entity, where the trigger condition corresponds to the first energy level satisfying a first threshold or the second energy level satisfying a second threshold.

In some examples of the method, UEs, and non-transitory computer-readable medium described herein, the energy report may be communicated based on the UE being in an idle mode or an inactive mode and the second discontinuous communication cycle may be associated with the idle mode of the UE or the inactive mode of the UE.

In some examples of the method, UEs, and non-transitory computer-readable medium described herein, the set of multiple sets of parameters includes a first set of multiple sets of parameters for the first type of discontinuous communication cycle and a second set of multiple sets of parameters for the second type of discontinuous communication cycle and the method, apparatuses, and non-transitory computer-readable medium may include further operations, features, means, or instructions for selecting a pair of discontinuous communication cycles according to which to communicate including one discontinuous communication cycle having a first set of parameters from the first plurality and one discontinuous communication cycle having a second set of parameters from the second plurality, where the first discontinuous communication cycle and the second discontinuous communication cycle may be included in the pair of discontinuous communication cycles.

Some examples of the method, UEs, and non-transitory computer-readable medium described herein may further include operations, features, means, or instructions for communicating one or more reports indicating one or more communication conditions associated with the UE, where selecting the pair of discontinuous communication cycles may be based on the one or more reports.

In some examples of the method, UEs, and non-transitory computer-readable medium described herein, each set of parameters of the plurality may be indicated as a respective discontinuous communication cycle configuration.

In some examples of the method, UEs, and non-transitory computer-readable medium described herein, the set of multiple sets of parameters may be for the first type of discontinuous communication cycle and each set of parameters of the plurality may be included in a same discontinuous communication cycle configuration of the first type.

In some examples of the method, UEs, and non-transitory computer-readable medium described herein, the set of multiple sets of parameters may be for the second type of discontinuous communication cycle and each set of parameters of the plurality may be included in a same discontinuous communication cycle configuration of the second type.

In some examples of the method, UEs, and non-transitory computer-readable medium described herein, each set of parameters of the plurality includes a respective periodicity of a corresponding discontinuous communication cycle, a respective on duration of the corresponding discontinuous communication cycle, a respective off duration of the corresponding discontinuous communication cycle, a respective start offset of the corresponding discontinuous communication cycle, one or more respective timers of the corresponding discontinuous communication cycle including a respective inactivity timer, or a combination thereof.

In some examples of the method, UEs, and non-transitory computer-readable medium described herein, the first and second type of discontinuous communication cycles include a DRX cycle for the UE, a DTX cycle for the UE, a DRX cycle for a network entity, or a DTX cycle for the network entity.

A method for wireless communications by a network entity is described. The method may include transmitting control signaling indicating respective parameters for a first type of discontinuous communication cycle and a second type of discontinuous communication cycle, where the control signaling indicates a set of multiple sets of parameters for at least one of the first type of discontinuous communication cycle or the second type discontinuous communication cycle, and where the first type of discontinuous communication cycle corresponds to discontinuous communication cycles having a greater periodicity than discontinuous communication cycles of the second type of discontinuous communication cycle, communicating according to a first discontinuous communication cycle of the first type or the second type in accordance with a first set of parameters of the set of multiple sets of parameters, and communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

A network entity for wireless communications is described. The network entity may include one or more memories storing processor executable code, and one or more processors coupled with the one or more memories. The one or more processors may individually or collectively operable to execute the code to cause the network entity to transmit control signaling indicating respective parameters for a first type of discontinuous communication cycle and a second type of discontinuous communication cycle, where the control signaling indicates a set of multiple sets of parameters for at least one of the first type of discontinuous communication cycle or the second type discontinuous communication cycle, and where the first type of discontinuous communication cycle corresponds to discontinuous communication cycles having a greater periodicity than discontinuous communication cycles of the second type of discontinuous communication cycle, communicating accord to a first discontinuous communication cycle of the first type or the second type in accordance with a first set of parameters of the set of multiple sets of parameters, and communicating accord to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

Another network entity for wireless communications is described. The network entity may include means for transmitting control signaling indicating respective parameters for a first type of discontinuous communication cycle and a second type of discontinuous communication cycle, where the control signaling indicates a set of multiple sets of parameters for at least one of the first type of discontinuous communication cycle or the second type discontinuous communication cycle, and where the first type of discontinuous communication cycle corresponds to discontinuous communication cycles having a greater periodicity than discontinuous communication cycles of the second type of discontinuous communication cycle, means for communicating according to a first discontinuous communication cycle of the first type or the second type in accordance with a first set of parameters of the set of multiple sets of parameters, and means for communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

A non-transitory computer-readable medium storing code for wireless communications is described. The code may include instructions executable by a processor to transmit control signaling indicating respective parameters for a first type of discontinuous communication cycle and a second type of discontinuous communication cycle, where the control signaling indicates a set of multiple sets of parameters for at least one of the first type of discontinuous communication cycle or the second type discontinuous communication cycle, and where the first type of discontinuous communication cycle corresponds to discontinuous communication cycles having a greater periodicity than discontinuous communication cycles of the second type of discontinuous communication cycle, communicating accord to a first discontinuous communication cycle of the first type or the second type in accordance with a first set of parameters of the set of multiple sets of parameters, and communicating accord to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

In some examples of the method, network entities, and non-transitory computer-readable medium described herein, the trigger condition includes traffic associated with one or more UEs served by the network entity satisfying a threshold, a priority of the traffic satisfying a threshold priority, a quality of service associated with the one or more UEs, one or more delay statuses associated with one or more DSRs from the one or more UEs, one or more energy levels associated with the one or more UEs, an expected quantity of data retransmissions based on one or more block error rates or one or more channel state information reports from the one or more UEs, a low-power wake up reception capability of the one or more UEs, or a combination thereof.

Some examples of the method, network entities, and non-transitory computer-readable medium described herein may further include operations, features, means, or instructions for receiving a set of indications from a set of UEs to switch to the second discontinuous communication cycle, where the trigger condition corresponds to the reception of the set of indications.

Some examples of the method, network entities, and non-transitory computer-readable medium described herein may further include operations, features, means, or instructions for communicating an indication associated with switching between discontinuous communication cycles, where the trigger condition corresponds to the communication of the indication.

In some examples of the method, network entities, and non-transitory computer-readable medium described herein, the indication includes an indication from a UE to switch to the second discontinuous communication cycle, an indication from a network entity to switch to the second discontinuous communication cycle, an end of burst indication from the UE, an end of burst indication from the network entity, a PDCCH skipping indication from the network entity, a DRX MAC-CE, an indication of a change of traffic from the network entity, one or more scheduling requests from the UE, one or more NACKs from the UE, one or more NACKs from the network entity, a BSR, an indication of XR traffic, a DSR, a SDR, or an energy report.

In some examples of the method, network entities, and non-transitory computer-readable medium described herein, the switch to the second discontinuous communication cycle may be based on a quantity of data associated with the BSR, an uplink packet data convergence protocol queueing delay associated with the DSR, an uplink packet data convergence protocol queueing delay associated with the SDR, a remaining packet delay budget indicated by the DSR for one or more LCHs or LCGs, a remaining packet delay budget indicated by the SDR for the one or more LCHs or LCGs, a charging rate indicated by the energy report, a discharging rate indicated by the energy report, an energy level associated with a UE indicated by the energy report, or an energy level prediction associated with the UE based on the energy report.

Some examples of the method, network entities, and non-transitory computer-readable medium described herein may further include operations, features, means, or instructions for receiving a request to switch from the first discontinuous communication cycle to the second discontinuous communication cycle, where the trigger condition corresponds to the reception of the request.

In some examples of the method, network entities, and non-transitory computer-readable medium described herein, the request may be communicated based on one or more communication conditions satisfying one or more thresholds, the one or more communication conditions including a buffer status associated with a BSR, a delay status associated with a DSR, an error status associated with an error status report, a traffic condition, or a combination thereof.

Some examples of the method, network entities, and non-transitory computer-readable medium described herein may further include operations, features, means, or instructions for communicating an energy report indicating a first energy level associated with a UE or a second energy level associated with a network entity, where the trigger condition corresponds to the first energy level satisfying a first threshold or the second energy level satisfying a second threshold.

In some examples of the method, network entities, and non-transitory computer-readable medium described herein, each set of parameters of the plurality may be indicated as a respective discontinuous communication cycle configuration and each set of parameters of the plurality may be included in a same discontinuous communication cycle configuration of the first type or the second type.

In some examples of the method, network entities, and non-transitory computer-readable medium described herein, the first and second type of discontinuous communication cycles include a DRX cycle for a UE, a DTX cycle for the UE, a DRX cycle for the network entity, or a DTX cycle for the network entity.

### BRIEF DESCRIPTION OF THE DRAWINGS

FIGS. 1 and 2 show examples of wireless communications systems that supports discontinuous communication cycle configuration switching in accordance with one or more aspects of the present disclosure.

FIG. 3 shows an example of a cycle diagram that supports discontinuous communication cycle configuration switching in accordance with one or more aspects of the present disclosure.

FIG. 4 shows an example of a process flow that supports discontinuous communication cycle configuration switching in accordance with one or more aspects of the present disclosure.

FIGS. 5 and 6 show block diagrams of devices that support discontinuous communication cycle configuration switching in accordance with one or more aspects of the present disclosure.

FIG. 7 shows a block diagram of a communications manager that supports discontinuous communication cycle configuration switching in accordance with one or more aspects of the present disclosure.

FIG. 8 shows a diagram of a system including a device that supports discontinuous communication cycle configuration switching in accordance with one or more aspects of the present disclosure.

FIGS. 9 and 10 show block diagrams of devices that support discontinuous communication cycle configuration switching in accordance with one or more aspects of the present disclosure.

FIG. 11 shows a block diagram of a communications manager that supports discontinuous communication cycle configuration switching in accordance with one or more aspects of the present disclosure.

FIG. 12 shows a diagram of a system including a device that supports discontinuous communication cycle configuration switching in accordance with one or more aspects of the present disclosure.

FIGS. 13 and 14 show flowcharts illustrating methods that support discontinuous communication cycle configuration switching in accordance with one or more aspects of the present disclosure.

### DETAILED DESCRIPTION

In some wireless communications, communication devices, such as a user equipment (UE) and a network entity, may support communicating according to a discontinuous communication cycle (e.g., a discontinuous reception (DRX) cycle, a discontinuous transmission (DTX) cycle), for example, to reduce power consumption. For example, a DRX cycle may include an active duration (e.g., an on duration) during which a communication device may receive messages and an inactive duration (e.g., an off duration) during which the communication device may enter a sleep state (e.g., a low power state, an inactive state, an OFF state) in which the communication device powers down (e.g., turns off) one or more components to reduce power consumption at the communication device. A DTX cycle may include an active duration during which a communication device may transmit messages and an inactive duration which the communication device may enter a sleep state. The communication device may not receive messages during an inactive duration of a DRX cycle and may not transmit messages during an inactive duration of a DTX cycle.

A configuration for a discontinuous communication cycle may define various parameters indicating how to operate (e.g., communicate) according to the discontinuous communication cycle, such as a duration (e.g., periodicity) of the cycle, an active duration, an inactive duration, a start offset (e.g., an offset to determine a starting slot of the cycle, such as a System Frame Number (SFN) offset), an inactivity timer duration, among others. In some cases, to adjust parameters of a discontinuous communication cycle, a UE may receive an indication of an updated (e.g., new) configuration, such as via RRC signaling, which may be associated with a relatively long latency. For example, a network entity may indicate an updated configuration to the UE based on traffic conditions (e.g., type of traffic, quantity of traffic) to improve power savings or latency. However, the relatively long latency associated with updating of cycle configurations may reduce the improvements to power savings or latency associated with indicating the updated configuration by delaying operation according the updated discontinuous communication cycle. In some cases, a UE may be configured with a short DRX cycle and a long DRX cycle and may transition between the cycles, for example, based on data activity. However, the UE may be configured with a single set of parameters for each of the short and long DRX cycles. Accordingly, to adjust parameters for the short or long DRX cycle, the network entity may indicate an updated configuration, which may similarly reduce the improvements to power savings or latency associated with adjusting the parameters.

In accordance with examples described herein, a UE and/or a network entity may be configured with multiple discontinuous communication cycle configurations such that the UE and/or network entity may dynamically switch between cycle configurations with reduced latency. For example, a network entity may configure a UE with multiple sets of parameters for one or more types of discontinuous communication cycles (e.g., long DRX cycles, short DRX cycles, long DTX cycles, short DTX cycles) according to which the network entity and the UE may communicate. As such, the UE and the network entity may switch from communicating according to a first discontinuous communication cycle to communicating according to a second discontinuous communication in accordance with respective sets of the multiple sets of parameters without the communication of signaling to indicate a new parameter set. As an example, if a UE is configured with multiple DRX long cycles and/or multiple DRX short cycles, the UE may dynamically switch between different long DRX cycles (e.g., having different periodicities, among other parameters), between different short DRX cycles, or between one of the long DRX cycles and one of the short DRX cycles, such as depending on traffic conditions.

The UE and the network entity may exchange signaling to coordinate (e.g., perform) dynamic switching between discontinuous communication cycle configurations. For example, the UE and/or the network entity may switch between discontinuous communication cycle configurations based on an indication communicated between the UE and network entity, a request communicated between the UE and network entity, or one or more reports communicated between the UE and network entity, among other possibilities described herein. By communicating such coordination signaling and supporting the configuration of multiple sets of parameters for discontinuous communication cycles (e.g., multiple sets of parameters within a single discontinuous communication cycle configuration, multiple discontinuous cycle configurations with respective sets of parameters), the UE and the network entity may support low latency switching between cycle configurations (e.g., without reconfiguration via RRC signaling). As such, the UE and the network entity may quickly switch between discontinuous cycle configurations in accordance with changing traffic conditions, which may support improved power savings and latency, among other benefits. For example, such low latency switching may enable the UE and/or network entity to quickly switch to a discontinuous communication cycle having a longer inactive duration, thereby increasing power savings. Additionally, or alternatively, such low latency switching may enable the UE and/or network entity to quickly switch to a discontinuous communication cycle having more frequent and/or longer active durations to support the communication of traffic with reduced latency, among other possibilities.

Aspects of the disclosure are initially described in the context of wireless communications systems. Aspects of the disclosure are additionally described in the context of a cycle diagram and a process flow. Aspects of the disclosure are further illustrated by and described with reference to apparatus diagrams, system diagrams, and flowcharts that relate to discontinuous communication cycle configuration switching.

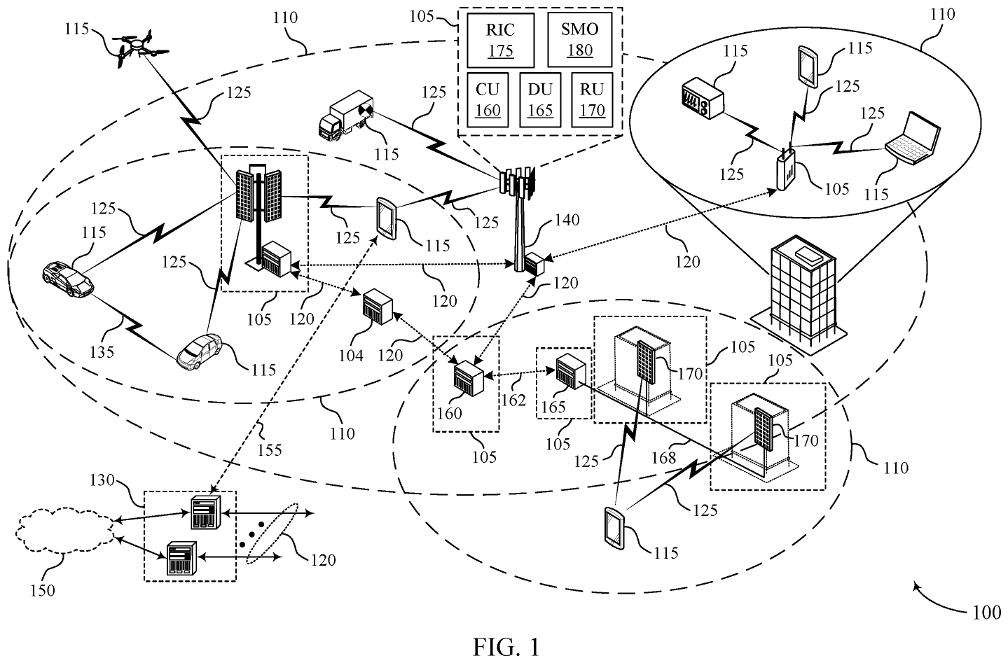

FIG. 1 shows an example of a wireless communications system 100 that supports discontinuous communication cycle configuration switching in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support discontinuous communication cycle configuration switching as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels (LCHs). A MAC layer may perform priority handling and multiplexing of LCHs into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 and a network entity 105 may support communicating according to various types of discontinuous communication cycles. For example, a UE 115 and/or a network entity 105 may support communicating according to a DRX cycle or a DTX cycle. A UE 115 and/or a network entity 105 may support various types of DRX cycles or DTX cycles. For example, a DRX cycle may be a long DRX cycle or a short DRX cycle, and a DTX cycle may be a long DTX cycle or a short DTX cycle, where long cycles may have longer periodicities (e.g., durations) than short cycles. For instance, a long cycle may have an active duration and an inactive duration that are together longer than a combined duration of an active duration and an inactive duration of a short cycle such that the short cycle recurs more frequently than the long cycle. In some examples, if both a short and long cycle are configured, a periodicity of the long cycle may be an integer multiple of a periodicity of the short cycle. In some examples, if both a short and long cycle are configured, a UE 115 and/or a network entity 105 may perform a wakeup (e.g., have an active duration) for the long cycle before waking up for one or more short cycles.

Discontinuous communication cycles may also be cycles for a UE 115 (which may be referred to as UE cycles) or cycles for a network entity (which may be referred to as cell cycles). For example, a UE discontinuous communication cycle may be a cycle indicating discontinuous communication (e.g., DRX, DTX) at the UE, and a cell discontinuous communication cycle may be a cycle indicating discontinuous communication at a cell, such as at a network entity 105 serving (e.g., supporting) the cell.

A network entity 105 may indicate a discontinuous communication cycle configuration to a UE 115 according to which the network entity 105 and the UE 115 may communicate. The discontinuous communication cycle configuration may include parameters indicating how to communicate according to the discontinuous communication cycle.

In accordance with examples described herein, multiple discontinuous communication cycle configurations may be indicated such that a network entity 105 and/or a UE 115 may dynamically switch between cycle configurations with reduced latency (e.g., relative to if a single cycle configuration is configured). For example, a network entity 105 may indicate multiple sets of parameters to a UE 115 that each correspond to a respective discontinuous communication cycle according to which the UE 115 and the network entity 105 may communicate. The network entity 105 and the UE 115 may communicate according to a first discontinuous communication cycle of the multiple indicated cycles and switch to communicating according to a second discontinuous communication cycle of the multiple indicated cycles based on a trigger condition, such as one or more messages communicated between the UE 115 and the network entity 105. In some examples, the multiple sets of parameters may be included in separate discontinuous cycle configurations indicated to the UE 115. In some examples, the multiple sets of parameters may be indicated as respective sets of parameters within a same discontinuous cycle configuration.

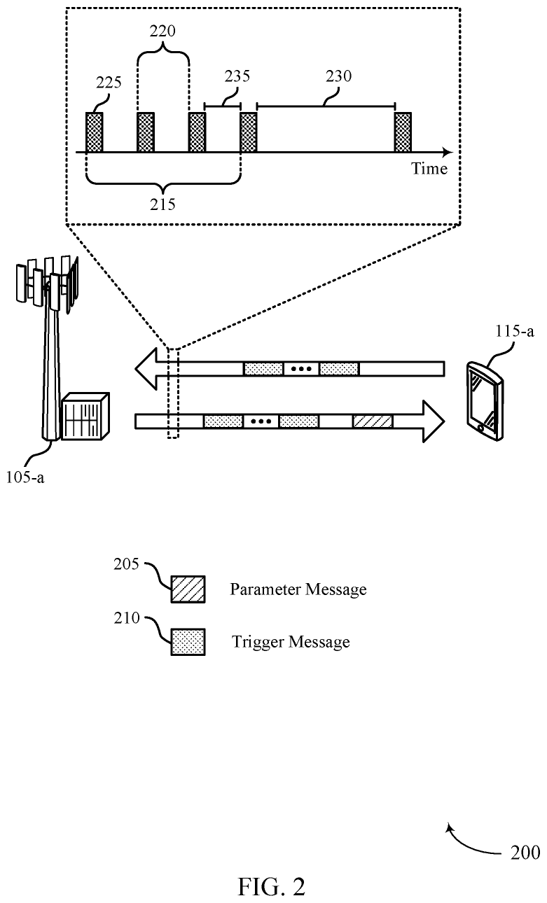

FIG. 2 shows an example of a wireless communications system 200 that supports discontinuous communication cycle configuration switching in accordance with one or more aspects of the present disclosure. The wireless communications system 200 may implement aspects of or may be implemented by aspects of the wireless communications system 100. For example, the wireless communications system 200 may include a UE 115-a and a network entity 105-a, which may be examples of corresponding devices as described herein, including with reference to FIG. 1.

The UE 115-a and the network entity 105-a may support communicating according to discontinuous communication cycles (e.g., a long discontinuous communication cycle 215, a short discontinuous communication cycle 220), such as DRX cycles, DTX cycles, UE cycles, cell cycles, or a combination thereof. The UE 115-a communicating according to a UE discontinuous communication cycle may include the UE 115-a entering and exiting a sleep state in accordance with an active duration and an inactive duration of the UE discontinuous communication cycle. The network entity 105-a communicating according to a UE discontinuous cycle may include the network entity 105-a communicating a message with the UE 115-a (e.g., transmit or receive a message depending on the type of discontinuous communication cycle) during the active duration of the UE discontinuous communication cycle such that UE 115-a may communicate the message (e.g., but not include the network entity 105-a entering and exiting the sleep state). As such, the network entity 105-a may know (e.g., determine, be configured with, or otherwise be aware of) the parameters of the UE discontinuous communication cycle such that the network entity 105-a and the UE 115-a may successfully communicate according to the UE discontinuous communication cycle. In some examples, the network entity 105-a may know the parameters based on transmitting (e.g., indicating) the parameters to the UE 115-a.

Similarly, the network entity 105-a communicating according to a cell discontinuous communication cycle may include the network entity 105-a entering and exiting a sleep state in accordance with an active duration and an inactive duration of the cell discontinuous communication cycle. The UE 115-a communicating according to a cell discontinuous cycle may include the UE 115-a communicating one or more messages with the network entity 105-a during the active duration of the cell discontinuous communication cycle such that network entity 105-a may communicate the message (e.g., but not include the UE 115-a entering and exiting the sleep state). As such, the UE 115-a may know (e.g., determine, be configured with, or otherwise be aware of) the parameters of the cell discontinuous communication cycle such that the network entity 105-a and the UE 115-a may successfully communicate according to the cell discontinuous communication cycle. In some examples, the UE 115-a may know the parameters based on receiving an indication of the parameters from the network entity 105-a.

In some examples, respective on durations of a UE DRX cycle and a cell DTX cycle may be aligned (e.g., at least partially overlapping) such that the network entity 105-a may transmit one or more messages during the on durations of the cell DTX cycle and the UE DRX cycle. Similarly, in some examples, respective on durations of a UE DTX cycle and a cell DRX cycle may be aligned such that the UE 115-a may transmit one or more messages to the network entity 105-a during the on durations of the UE DTX cycle and the cell DRX cycle.

The network entity 105-a and the UE 115-a may support communicating according to various types of discontinuous communication cycles, such as a long discontinuous communication cycle 215, a short discontinuous communication cycle 220, or a combination thereof. Long discontinuous communication cycles 215 may be associated with longer (e.g., greater) periodicities than short discontinuous communication cycles 220. For example, a long discontinuous communication cycle 215 may include an active duration 225 and an inactive duration 230. A short discontinuous communication cycle 220 may include an active duration 225 and an inactive duration 235 that is shorter than the inactive duration 230. As such, short discontinuous communication cycles 220 may recur more frequently than long discontinuous communication cycles 215. In some examples, a long discontinuous communication cycle 215 may have a duration that is an integer multiple of a duration of a short discontinuous communication cycle 220.

In some cases, the UE 115-a may be configured with both a long DRX cycle and a short DRX cycle. In some cases, the UE 115-a may transition between the long DRX cycle and the short DRX cycle based on data activity. For example, if there is no data activity (e.g., no reception of a message, such as a physical downlink control channel (PDCCH) message) during the active duration 225 of the long DRX cycle, the UE 115-a may continue to operate according to the long DRX cycle. If there is data activity, the UE 115-a may switch to the short DRX cycle for a duration of time. If there is no additional data activity during the duration of time, the UE 115-a may switch back to the operating according to the long DRX cycle. Operating according to a short DRX cycle after recent data activity may be useful for reducing communication latency as the probability that the UE 115-a is scheduled again within the duration of time after data activity may be higher. In some cases, however, the UE 115-a may be configured with a single set of parameters for the long and short DRX cycles (e.g., single possible durations for an active duration 225, an inactive duration 230, or an inactive duration 235, a single possible inactivity timer duration, a single possible start offset, and so on). To update any of these parameters, the network entity 105-a may transmit updated parameters (e.g., an updated cycle configuration) to the UE 115-a, such as via RRC signaling, which may increase a latency at which the UE 115-a is able to switch to operating according to the updated parameters.

To reduce latency associated with switching between discontinuous communication cycles, the UE 115-a and/or the network entity 105-a may be configured with multiple sets of parameters for multiple discontinuous communication cycles. For example, the network entity 105-a may transmit a parameter message 205 to the UE 115-a that indicates the multiple sets of parameters to the UE 115-a. In some examples, the parameter message 205 may include multiple sets of parameters for a long discontinuous communication cycle 215, multiple sets of parameters for a short discontinuous communication cycle 220, or a combination thereof. In some examples, the parameter message 205 may include multiple sets of parameters for a UE discontinuous communication cycle, multiple sets of parameters for a cell discontinuous communication cycle, or a combination thereof. That is, instead of indicating a single discontinuous communication cycle configuration to the UE 115-a, the network entity 105-a may indicate multiple discontinuous communication cycle configurations for a same type of discontinuous communication cycle to the UE 115-a according to which the UE 115-a and the network entity 105-a may communicate. In some examples, the parameter message 205 may indicate multiple discontinuous communication cycle configurations for each type of discontinuous communication cycle. In some examples, the parameter message 205 may indicate multiple discontinuous communication cycle configurations for one or more types of discontinuous communication cycles and indicate a single discontinuous communication cycle configuration for one or more other types of discontinuous communication cycles.

Each set of parameters may correspond to a respective discontinuous communication cycle according to which the UE 115-a and the network entity 105-a may communicate. That is, the UE 115-a and the network entity 105-a may communicate according to a discontinuous communication cycle in accordance with (e.g., using) a corresponding set of parameters.

In some examples, the parameter message 205 may indicate the multiple sets of parameters for the same type of discontinuous communication cycle as separate discontinuous communication cycle configurations of the same type. In some examples, the parameter message 205 may indicate the multiple sets of parameters for the same type of discontinuous communication cycle as respective sets of parameters within a same discontinuous communication cycle configuration. In some examples, the parameter message 205 may indicate multiple possible (e.g., candidate) values for one or more of the parameters and a single possible value for one or more other parameters. For example, the parameter message 205 may indicate multiple possible active durations and inactive durations, while indicating a single possible inactivity timer duration (although other combinations are possible). In some examples, the parameter message 205 may be communicated as a single message or as multiple messages.

The UE 115-a and the network entity 105-a may switch between discontinuous communication cycles configured by the parameter message 205 to support reduced power consumption or reduced latency, among other benefits. For example, if there is low traffic or no traffic for a duration, power consumption may be reduced by switching to a longer discontinuous communication cycle as quickly as possible. Additionally, or alternatively, if the UE 115-a has high priority data or a packet delay is approaching a threshold, the UE 115-a may switch to a short discontinuous communication cycle as quickly as possible. Because multiple discontinuous communication cycles are configured by the parameter message 205, the UE 115-a and the network entity 105-a may exchange signaling, such as one or more trigger messages 210, to coordinate (e.g., support) switching between different discontinuous communication cycles configured by the parameter message 205. For example, the signaling may be exchanged to ensure that the UE 115-a and the network entity 105-a communicate according to a same discontinuous communication cycle of the multiple configured discontinuous communication cycles.

The UE 115-a and the network entity 105-a may switch between communicating according to different discontinuous communication cycles based on identifying a trigger condition. The trigger condition may be the communication of one or more trigger messages 210. For example, the UE 115-a and the network entity 105-a may switch from communicating according to a first discontinuous communication cycle configured by the parameter message 205 to a second discontinuous communication cycle configured by the parameter message 205 based on (e.g., in response to) communicating the one or more trigger messages 210. In some examples, the UE 115-a and the network entity 105-a may switch from a first discontinuous communication cycle of a first type to a second discontinuous communication cycle of the first type (e.g., from a first set of parameters of multiple sets of parameters configured for the first type to a second set of parameters of the multiple sets of parameters). In some examples, the UE 115-a and the network entity 105-a may switch from a first discontinuous communication cycle of a first type to a second discontinuous communication cycle of a second type, where multiple sets of parameters may be configured for one or both of the first type and the second type. For example, the first discontinuous communication cycle may correspond to one of multiple sets of parameters configured for the first type, and/or the second discontinuous communication cycle may correspond to one of multiple sets of parameters configured for the second type.

In some examples, a trigger message 210 may be an indication from the UE 115-a to switch to the second discontinuous communication cycle. For example, the UE 115-a may transmit the trigger message 210 to the network entity 105-a (e.g., via a MAC-control element (MAC-CE), via uplink control information (UCI)) indicating to switch to the second discontinuous communication cycle, and the UE 115-a and the network entity 105-a may switch to second discontinuous communication cycle based on (e.g., in response to, after) the transmission of the trigger message 210. In some examples, a trigger message 210 may be an indication from the network entity 105-a to switch to the second discontinuous communication cycle. For example, the network entity 105-a may transmit the trigger message 210 to the UE 115-a (e.g., via a MAC-CE, via downlink control information (DCI)) indicating to switch to the second discontinuous communication cycle, and the UE 115-a and the network entity 105-a may switch to second discontinuous communication cycle based on (e.g., in response to, after) the transmission of the trigger message 210.

In some examples, a trigger message 210 may be an end of burst indication from the UE 115-a or the network entity 105-a. For example, the UE 115-a may include an end of burst indication in a message transmitted to the network entity 105-a (e.g., a last message of a burst). Alternatively, the network entity 105-a may include an end of burst indication in a message transmitted to the UE 115-a. The end of burst indication may indicate an end of a set of traffic transmitted by the UE 115-a or the network entity 105-a and may thus indicate that the UE 115-a and the network entity 105-a may switch to a discontinuous communication cycle associated with reduced power consumption. For example, the second discontinuous communication cycle may correspond to a set of parameters associated with reduced power consumption, such as a longer periodicity, a shorter active duration 225, a longer inactive duration 230 or 235, a shorter inactivity timer duration, or a combination thereof, relative to the first discontinuous communication cycle, based on the communication of the end of burst indication.

In some examples, a trigger message 210 may be a PDCCH skipping indication from the network entity 105-a. For example, the network entity 105-a may transmit a PDCCH skipping occasion that indicates for the UE 115-a to skip monitoring one or more PDCCH occasions. Here, the second discontinuous communication cycle may be associated with reduced power consumption relative to the first discontinuous communication cycle. For example, due to skipping monitoring of one or more PDCCH occasions, the UE 115-a may remain in a sleep state for the PDCCH occasions to be skipped to reduce power consumption. Accordingly, the second discontinuous communication cycle may correspond to a set of parameters associated with reduced power consumption.

In some examples, a trigger message 210 may be a DRX MAC-CE from the network entity 105-a. For example, the network entity 105-a may transmit a DRX MAC-CE (e.g., a MAC-CE command) to indicate the UE 115-a to terminate an active duration 225 of a discontinuous communication cycle (e.g., a DRX cycle), and the UE 115-a may terminate monitoring of scheduling DCI based on the DRX MAC-CE. Here, the second discontinuous communication cycle may correspond to a set of parameters associated with reduced power consumption relative to the first discontinuous communication cycle.

In some examples, a trigger message 210 may be an indication of a change of traffic (e.g., a traffic statistics indication) from the network entity 105-a. For example, the network entity 105-a may transmit the indication of the change of traffic to the UE 115-a based on one or more conditions, such as a change to a periodicity of the traffic between the network entity 105-a and the UE 115-a. In some examples, the indication may indicate the change of the periodicity, and the UE 115-a and the network entity 105-a may switch discontinuous communication cycles in accordance with the change of the periodicity. For example, if the periodicity is indicated as increasing (e.g., longer durations between the traffic), the second discontinuous communication cycle may correspond to a set of parameters having a longer periodicity (e.g., a longer inactive duration) relative to the first discontinuous communication cycle (although other parameter differences between the first and second discontinuous communication cycles are possible). For instance, the switch may be from a short discontinuous communication cycle 220 to a long discontinuous communication cycle 215, from a first long discontinuous communication cycle 215 to a second long discontinuous communication cycle 215 that is longer than the first long discontinuous communication cycle 215, or from a first short discontinuous communication cycle 220 to a second short discontinuous communication cycle 220 that is longer than the first short discontinuous communication cycle 220. Alternatively, if the periodicity is indicated as decreasing (e.g., shorter durations between the traffic), the second discontinuous communication cycle may correspond to a set of parameters having a shorter periodicity (e.g., a shorter inactive duration) relative to the first discontinuous communication cycle.

In some examples, the trigger condition may be the communication of one or more trigger messages 210, where the trigger messages 210 are one or more scheduling request from the UE 115-a. For example, the UE 115-a may transmit a scheduling request to the network entity 105-a, and the UE 115-a and the network entity 105-a may switch to the second discontinuous communication cycle based on the scheduling request. The second discontinuous communication cycle may be associated with reduced power consumption or reduced latency based on the traffic requested by the UE 115-a via the scheduling request. For example, depending on the traffic requested by the scheduling request, the second discontinuous communication cycle may correspond to a set of parameters associated with reduced power consumption or a set of parameters associated with reduced latency, such as a shorter periodicity, a longer active duration 225, a shorter inactive duration 230 or 235, a longer inactivity timer duration, or a combination thereof, relative to the first discontinuous communication cycle. In some examples, the second discontinuous communication cycle may have a start offset parameter that is based on the traffic requested (e.g., corresponds to a resource via which the requested traffic is to be communicated). In some examples, the UE 115-a may transmit a threshold quantity of scheduling requests, and the UE 115-a and the network entity 105-a may switch to the second discontinuous communication cycle based on the threshold quantity being satisfied (e.g., met, exceeded). In some examples, the one or more scheduling requests may be for a particular type of LCH (e.g., broadcast control channel (BCCH), paging control channel (PCCH), common control channel (CCCH), dedicated control channel (DCCH), dedicated traffic channel (DTCH)) or LCH group (LCG), and the switch may be based on the one or more scheduling requests being for the particular type of LCH or LCG.

In some examples, the trigger condition may be the communication of one or more trigger messages 210, where the trigger messages 210 are one or more negative acknowledgements (NACKs) from the UE 115-a or from the network entity 105-a. For example, the UE 115-a may transmit a NACK to the network entity 105-a, or the network entity 105-a may transmit a NACK to the UE 115-a (e.g., if the network entity 105-a and the UE 115-a are communicating via an unlicensed frequency band). The UE 115-a and the network entity 105-a may switch to the second discontinuous communication cycle based on the communication of the NACK. For instance, the second discontinuous communication cycle may correspond to a set of parameters associated with reduced latency relative to the first discontinuous communication cycle to support reduced latency of a retransmission of data associated with the NACK. In some examples, the switch to the second discontinuous communication cycle may be based on a threshold quantity of NACKs being transmitted by the UE 115-a or the network entity 105-a.

In some examples, the trigger message 210 may be a buffer state report (BSR) from (e.g., transmitted by) the UE 115-a, and the switch to the second discontinuous communication cycle may be based on information indicated by the BSR. For example, the BSR may indicate a quantity of data in uplink buffers of the UE 115-a that are available for transmission. If the quantity of data satisfies (e.g., meets or exceeds) a threshold quantity of data, the UE 115-a and the network entity 105-a may switch to the second discontinuous communication cycle corresponding to a set of parameters associated with reduced latency relative to the first discontinuous communication cycle, for example, to reduce a latency at which the data in the uplink buffers is transmitted to the network entity 105-a. Alternatively, if the quantity of data fails to satisfy a threshold quantity of data, the UE 115-a and the network entity 105-a may switch to the second discontinuous communication cycle corresponding to a set of parameters associated with reduced power consumption relative to the first discontinuous communication cycle or may refrain from switching cycles. In some examples, the BSR may be associated with one or more types of LCHs or LCGs (e.g., data in the uplink buffers may correspond to the one or more types of LCHs or LCGs), and the switch to the second discontinuous communication cycle may be based on the one or more types of LCHs or LCGs associated with the BSR. For example, the UE 115-a and the network entity 105-a may switch to a reduced latency discontinuous communication cycle if the BSR indicates data associated with one or more types of LCHs or LCGs (e.g., associated with higher priority traffic) but not if the BSR indicates data associated with one or more other types of LCHs or LCGs (e.g., associated with lower priority traffic).

In some examples, the trigger message 210 may be an indication of extended reality (XR) traffic from the UE 115-a or the network entity 105-a. For example, XR traffic may be periodic, and the indication of XR traffic may indicate a periodicity of the traffic to be transmitted by the UE 115-a or network entity 105-a. As such, the UE 115-a and the network entity 105-a may switch to the second discontinuous communication cycle corresponding to a set of parameters that is based on the periodicity of the XR traffic. For example, the set of parameters may indicate a periodicity based on the periodicity of the XR traffic, such as a periodicity that matches the periodicity of the XR traffic or a periodicity that results in alignment of (e.g., at least partial overlap of) the communication of the XR traffic and an active duration 225 of the second discontinuous communication cycle (e.g., a periodicity that is a unit fraction of or an integer multiple of the periodicity of the XR traffic). Additionally, or alternatively, the set of parameters may indicate a start offset such that an active duration 225 of the second discontinuous communication cycle aligns with (e.g., at least partially overlaps with) the communication of the XR traffic.

In some examples, the trigger message 210 may be a delay status report (DSR) or a statistical delay report (SDR) from the UE 115-a, and the switch to the second discontinuous communication cycle may be based on information indicated by the DSR or the SDR. For example, the DSR or the SDR may indicate a T_{wait} parameter, which may indicate an uplink packet data convergence protocol (PDCP) queueing delay. For example, the uplink PDCP queuing delay may be the delay from packet arrival at PDCP upper service access point (SAP) until an uplink grant to transmit the packet is available. This delay may include the delay the UE is granted resources from sending a scheduling request or random access channel (RACH) to receive the uplink grant. If the uplink PDCP queueing delay satisfies (e.g., meets or exceeds) a threshold delay, the UE 115-a and the network entity 105-a may switch to the second discontinuous communication cycle having a longer active duration 225, for example, to increase a likelihood that is able to be successfully communicated. Alternatively, if the uplink PDCP queueing delay fails to satisfy a threshold delay, the UE 115-a and the network entity 105-a may switch to the second discontinuous communication cycle having a shorter active duration 225, for example, to reduce power consumption. In some examples, one or more threshold delays may be configured, for example, corresponding to different active durations 225 that may be used if satisfied.

Additionally, or alternatively, the DSR or the SDR may indicate a remaining packet delay budget, such as associated with one or more LCHs or LCGs. In some examples, if the remaining packet delay budget satisfies (e.g., meets or exceeds) a threshold budget, the UE 115-a and the network entity 105-a may switch to the second discontinuous communication cycle having a longer active duration 225, for example, to give the UE 115-a and the network entity 105-a additional time to communicate. Alternatively, if the remaining packet delay budget fails to satisfy a threshold budget, the UE 115-a and the network entity 105-a may switch to the second discontinuous communication cycle having a shorter active duration 225, for example, to save power. In some examples, one or more threshold budgets may be configured, for example, corresponding to different active durations 225 that may be used if satisfied

In some examples, the trigger message 210 may be an energy report, and the switch to the second discontinuous communication cycle may be based on information indicated by the energy report. For example, the energy report may indicate an energy level of the UE 115-a, a charging rate of the energy of the UE 115-a, a discharging rate of the energy of the UE 115-a, an energy level prediction associated with the UE 115-a (e.g., a prediction of a future energy level of the UE 115-a, such as based on current charging and/or discharging rates), or a combination thereof. In some examples, the UE 115-a and the network entity 105-a may switch to the second discontinuous communication cycle associated with reduced power consumption based on the energy report. For example, if the energy report indicates an energy level or predicted energy level that fails to satisfy (e.g., is less than, is less than or equal to) a threshold energy level, the UE 115-a and the network entity 105-a may switch to the reduced power consumption discontinuous communication cycle to reduce power consumption at the UE 115-a. Additionally, or alternatively, if the energy report indicates a discharging rate that satisfies (e.g., meets or exceeds) a threshold discharging rate and/or if the charging rate fails to satisfy (e.g., is less than, is less than or equal to) a threshold charging rate, the UE 115-a and the network entity 105-a may switch to the reduced power consumption discontinuous communication cycle.

Alternatively, the UE 115-a and the network entity 105-a may switch to the second discontinuous communication cycle associated with reduced latency based on the energy report. For example, if the energy report indicates an energy level or predicted energy level that satisfies (e.g., meets or exceeds) a threshold energy level, the UE 115-a and the network entity 105-a may switch to the reduced latency discontinuous communication cycle, for example, based on the UE 115-a having sufficient energy to operate at the reduced latency discontinuous communication cycle to support reduced latency communications. Additionally, or alternatively, if the energy report indicates a discharging rate that fails to satisfy (e.g., is less than, is less than or equal to) a threshold discharging rate and/or if the charging rate satisfies (e.g., meets or exceeds) a threshold charging rate, the UE 115-a and the network entity 105-a may switch to the reduced latency discontinuous communication cycle.

In some examples, an energy report may be transmitted while the UE 115-a is in an inactive mode or while the UE 115-a is in an idle mode. In some examples, the second discontinuous communication cycle may be associated with the idle mode or the inactive mode based on the energy report. For example, the second discontinuous communication cycle may be designated as (e.g., identified as) an idle mode discontinuous communication cycle or an inactive mode discontinuous communication cycle. In some examples, the UE 115-a may transmit the energy report via layer 1 (L1) signaling, layer 2 (L2) signaling, layer 3 (L3) signaling, or a combination thereof. In some examples, the UE 115-a may multiplex the energy report with L1 signaling, L2 signaling, L2 signaling, or a combination thereof, to transmit the energy report. In some examples, the UE 115-a may transmit the energy report via upper layer signaling (e.g., application layer signaling).

In some examples, the trigger message 210 may be a request from the UE 115-a to switch to the second discontinuous communication cycle. In some examples, the UE 115-a may transmit the request based on one or more communication conditions satisfying one or more thresholds. For example, the one or more communication conditions may include a buffer status associated with a BSR (e.g., a quantity of data included in uplink buffers), a delay status associated with a DSR (e.g., a T_{wait} parameter, a remaining packet delay budget), an error status associated with an error status report, a traffic condition, or a combination thereof. In some examples, the traffic condition may be an end of burst indication, a PDCCH skipping occasion, a periodicity of traffic (e.g., XR traffic to be communicated), traffic (e.g., resources) requested by the UE 115-a, a priority of traffic, or a combination thereof.

In some examples, the UE 115-a may transmit the request via L1 signaling, L2 signaling, L3 signaling, or a combination thereof. For example, for L1 signaling, the UE 115-a may transmit the request via UCI sent on a physical uplink control channel (PUCCH) or a physical uplink shared channel (PUSCH). For L2 signaling, the request may be transmitted via a MAC-CE. For L3 signaling, the request may be transmitted via RRC signaling, such as via user assistant information (UAI).

In some examples, the UE 115-a may multiplex the request with L1 signaling, L2 signaling, L3 signaling or a combination thereof, to transmit the request. For example, the UE 115-a may multiplex the request with a message that include a scheduling request, a HARQ-acknowledgement (ACK) message (e.g., an ACK, a NACK), an uplink reference signal (e.g., a sounding reference signal (SRS)) a BSR, a power headroom report (PHR), a CSI report, or a combination thereof.

In some examples, the UE 115-a and the network entity 105-a may be configured such that the switch occurs in response to the request transmitted by the UE 115-a. In some examples, the UE 115-a and the network entity 105-a may be configured such that the network entity 105-a confirms or denies the switch requested by the UE 115-a. In some examples, whether the UE 115-a and the network entity 105-a switch in response to the request or a confirmation (e.g., or lack of denial) by the network entity 105-a may be a feature that is enabled or disabled via signaling (e.g., L1, L2, L3 signaling) from the network entity 105-a.

In some examples, the network entity 105-a may request for the UE 115-a to indicate a desired discontinuous communication cycle configuration, and the switch to the second discontinuous communication cycle may be based on the request from the network entity 105-a. For example, the UE 115-a may transmit the request, including an indication of the discontinuous communication cycle to which to switch, in response to the request from the network entity 105-a.

By supporting the dynamic switching between discontinuous communication cycles configured via the parameter message 205, the UE 115-a and the network entity 105-a may reduce latency associated with switching between discontinuous communication cycles, which may improve power consumption, latency, resource utilization efficiency, and coordination between the UE 115-a and the network entity 105-a. For example, the UE 115-a and the network entity 105-a may reduce latency associated with switching the discontinuous communication cycles that better support current traffic and/or device conditions (e.g., energy levels, charging/discharging rates).

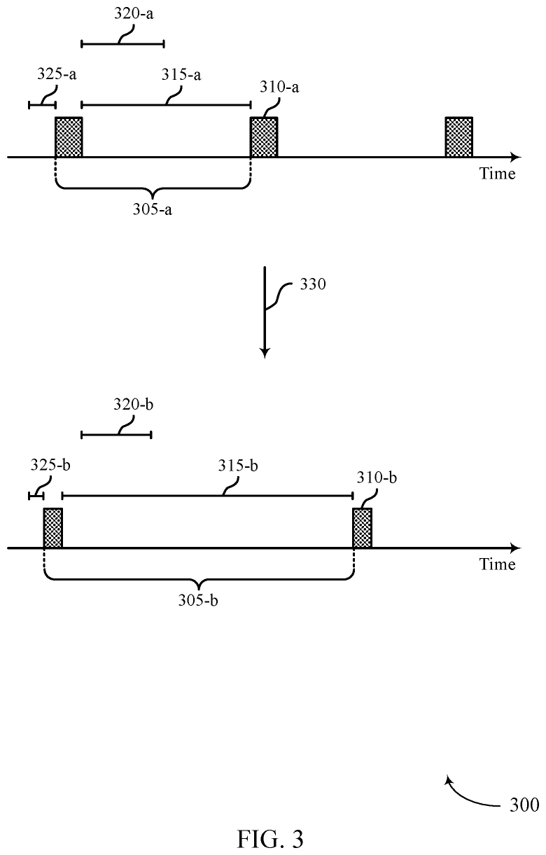

FIG. 3 shows an example of a cycle diagram 300 that supports discontinuous communication cycle configuration switching in accordance with one or more aspects of the present disclosure. The cycle diagram 300 may be implemented by aspects of the wireless communications systems 100 or 200. For example, the cycle diagram 300 may be implemented by a UE 115 or a network entity 105 as described herein, including with reference to FIGS. 1 and 2.

The cycle diagram 300 depicts discontinuous communication cycles 305. The UE 115 and the network entity 105 may be configured with respective sets of parameters corresponding to the discontinuous communication cycles 305, such as via one or more parameter messages 205. For example, the cycle diagram 300 includes a discontinuous communication cycle 305-a and a discontinuous communication cycle 305-b. Each discontinuous communication cycle 305 may be associated with a respective active duration 310, a respective inactive duration 315, a respective duration (e.g., corresponding to a combination of the active duration 310 and the inactive duration 315), a respective inactivity timer duration 320, a respective slot offset 325, or a combination thereof, among other parameters that may be associated with a discontinuous communication cycle 305. For example, the discontinuous communication cycle 305-a may have an active duration 310-a, an inactive duration 315-a, an inactivity timer duration 320-a, and a slot offset 325-a, and the discontinuous communication cycle 305-b may have an active duration 310-b, an inactive duration 315-b, an inactivity timer duration 320-b, and a slot offset 325-b. In the example of FIG. 3, the discontinuous communication cycles 305 may be of a same type.

The UE 115 and the network entity 105 may support performing a switch 330 from the discontinuous communication cycle 305-a to the discontinuous communication cycle 305-b, such as based on a trigger condition (e.g., the communication of one or more trigger messages 210). The parameters of the discontinuous communication cycle 305-a and the parameters of the discontinuous communication cycle 305-b may differ based on the trigger condition. In the example of FIG. 3, the discontinuous communication cycle 305-b may be associated with reduced power consumption relative to the discontinuous communication cycle 305-a. For example, the active duration 310-b may be shorter than the active duration 310-a, the inactive duration 315-b may be longer than the inactive duration 315-a, and the inactivity timer duration 320-b may be shorter than the inactivity timer duration 320-a, each of which may support reduced power consumption relative to the discontinuous communication cycle 305-a. In some examples, the slot offset 325-b may be different from the slot offset 325-a, for example, to align with resources used to communicate traffic (e.g., to align with a communication of periodic XR traffic). Other differences between respective parameter sets of the discontinuous communication cycles 305 are possible, such as to support reduced latency, alignment of traffic and active durations 310, or both.

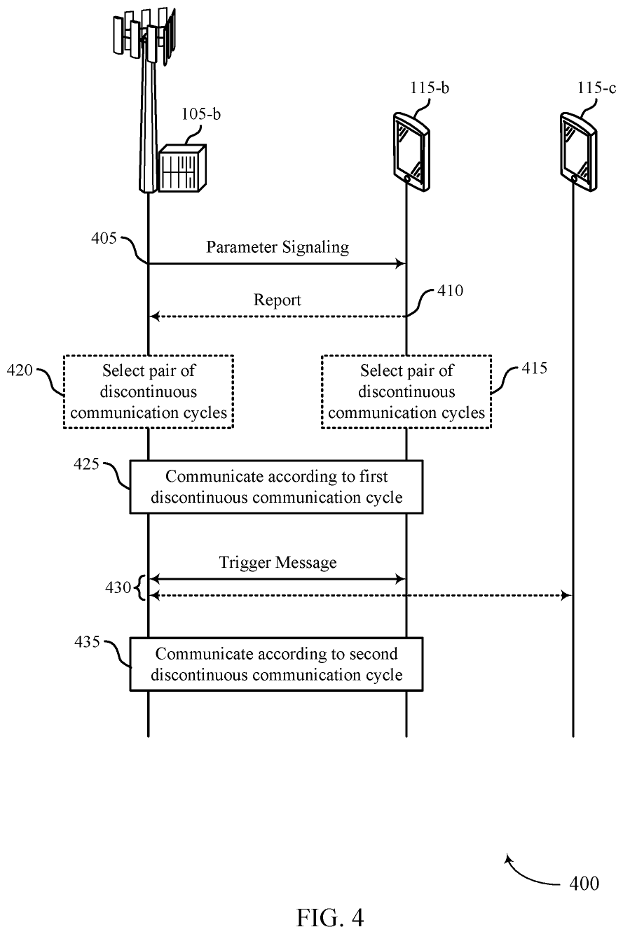

FIG. 4 shows an example of a process flow 400 that supports discontinuous communication cycle configuration switching in accordance with one or more aspects of the present disclosure. The process flow 400 may implement aspects of or may be implemented by aspects of the wireless communications system 100, the wireless communications system 200, or the cycle diagram 300. For example, the process flow 400 may be implemented by a network entity 105-b and one or more UEs 115 (e.g., a UE 115-b, a UE 115-c), which may be examples of the corresponding devices as described here, including with reference to FIGS. 1 through 3.

In the following description of the process flow 400, the operations between the network entity 105-b and the UEs 115 may be performed in a different order than the example order shown. Some operations may also be omitted from the process flow 400, and other operations may be added to the process flow 400. Further, although some operations or signaling may be shown to occur at different times for discussion purposes, these operations may actually occur at the same time.

At 405, the network entity 105-b may transmit parameter signaling to the UE 115-b. The parameter signaling may indicate respective parameters for one or more types of discontinuous communication cycles. For example, the parameter signaling may indicate multiple sets of parameters for a first type of discontinuous communication cycle (e.g., a long discontinuous communication cycle), multiple sets of parameters for a second type of discontinuous communication cycle (e.g., discontinuous communication cycle), or a combination thereof. In some examples, the network entity 105-b may transmit the parameter signaling to the UE 115-c. In some examples, the parameter transmitted to the UE 115-c may indicate the same sets of parameters as the parameter signaling transmitted to the UE 115-b. In some examples, one or more parameter sets of the parameter signaling transmitted to the UE 115-c may be different than the parameter sets indicated by the parameter signaling transmitted to the UE 115-b.

At 410, the UE 115-b may transmit one or more reports to the network entity 105-b. For example, the UE 115-b may transmit one or more BSRs, DSRs, SDRs, error status reports, energy reports, or a combination thereof.

At 415, the UE 115-b may select a pair of discontinuous communication cycles from the discontinuous communication cycles indicated by the parameter signaling. For example, the parameter signaling may indicate multiple long discontinuous communication cycles and multiple short discontinuous communication cycles. The UE 115-b may select the pair to include one long discontinuous communication cycle and one short discontinuous communication cycle between which the UE 115-b may dynamically switch, such as based on a trigger condition. In some examples, the UE 115-b may select the pair based on the one or more reports. For example, the UE 115-b may use the information indicated by the one or more reports to determine discontinuous communication cycles to support (e.g., accommodate) traffic and/or device conditions associated with the UE 115-b, such as based on whether one or more conditions are satisfied by the information indicated in the reports, as described with reference to FIG. 2. In some examples, the long discontinuous communication cycle selected for the pair may have a periodicity corresponding to a periodicity of traffic communicated between the UE 115-b and the network entity 105-b. In some examples, the short discontinuous communication cycle selected for the pair may be based on a arrival time uncertainty associated with the data, packet size uncertainty associated with the data, or a combination thereof (e.g., determined based on the communication of the one or more reports).

At 420, the network entity 105-b may select the pair of discontinuous communication cycles, such as based on the one or more reports.

At 425, the UE 115-b and the network entity 105-b may communicate according to a first discontinuous communication cycle of the discontinuous communication cycles indicated via the parameter signaling. In some examples, the UE 115-c and the network entity 105-b may communicate according to the first discontinuous communication cycle or according to another discontinuous communication cycle indicated via the parameter signaling transmitted to the UE 115-c.

At 430, the UE 115-b and the network entity 105-b may communicate one or more trigger messages (e.g., trigger messages 210). In some examples, the UE 115-c and the network entity 105-b may communicate one or more trigger messages.

At 435, the UE 115-b and the network entity 105-b may communicate according to a second discontinuous communication cycle of the discontinuous communication cycles indicated via the parameter signaling. For example, based on (e.g., in response to, after) the communication of the one or more trigger messages, the UE 115-b and the network entity 105-b may switch to communicate according to the second discontinuous communication cycle.

In some examples, the network entity 105-b may support switching between different cell discontinuous communication cycles (e.g., indicated via the parameter signaling) based on network preference, such as based on whether the network entity 105-b wants to conserve power or serve UEs 115 with lower latency. For example, the network entity 105-b may support cell discontinuous communication cycle switching based on a network state, one or more trigger messages communicated between the network entity 105-b and a set of UEs 115 (e.g., the UE 115-b and the UE 115-c), traffic conditions between the network entity 105-b and the set of UEs 115, or a combination thereof. For instance, the network state may consider latency of traffic to be communicated via a cell served by the network entity 105-b, loading conditions of the cell, energy levels of UEs 115 within the cell, traffic priority, among other factors, which the network entity 105-b may use to determine a cell discontinuous communication cycle according to which the operate.

In some examples, a trigger condition for the network entity 105-b to switch to the second discontinuous communication cycle may include traffic associated with the set of UEs 115 satisfying a threshold. For example, if a quantity of the traffic satisfies (e.g., meets or exceeds) a threshold, the network entity 105-b may switch to a cell discontinuous communication cycle having a longer active duration to support communication of the traffic. Alternatively, if the quantity of traffic fails to satisfy a threshold, the network entity 105-b may switch to a cell discontinuous communication cycle having a shorter active duration to reduce power consumption.

In some examples, the trigger condition may include a priority of the traffic satisfying (e.g., meeting or exceeding) a threshold priority. For example, if the priority satisfies the threshold priority, the network entity 105-b may switch to a cell discontinuous communication cycle having a longer active duration to support lower latency communication of the traffic. Alternatively, if the priority fails to satisfy a threshold priority, the network entity 105-b may switch to a cell discontinuous communication cycle having a shorter active duration to reduce power consumption. In some examples, the priority of the traffic may be determined based on one or more scheduling requests, one or more BSRs, one or more DSRs, or a combination thereof communicated with the network entity 105-b.

In some examples, the trigger condition may include a quality of service (QoS) associated with serving the set of UEs 115. For example, if the QoS satisfies a threshold QoS, the network entity 105-b may switch to a cell discontinuous communication cycle associated with reduced latency to satisfy the QoS constraints. Alternatively, if the QoS fails to satisfy a threshold QoS, the network entity 105-b may switch to a cell discontinuous communication cycle associated with reduced power consumption.

In some examples, the trigger condition may include one or more energy levels associated with the set of UEs 115. For example, if energy levels of the UEs 115 fail to satisfy a threshold, the network entity 105-b may switch to a cell discontinuous communication cycle associated with reduced power consumption, such as to reduce power consumption at the UEs 115 associated with communicating with the network entity 105-b. In some examples, if energy levels of the UEs 115 satisfy a threshold, the network entity 105-b may switch to a cell discontinuous communication cycle associated with reduce latency, such as to serve the UEs 115 with reduced latency.

In some examples, the trigger condition may include an expected quantity of data retransmissions, such as based on one or more block error rates (BLER) (e.g., estimated BLERs), one or more CSI reports (e.g., predicted CSI reports) from the set of UEs 115, or a combination thereof. For example, the network entity 105-b may determine the expected quantity of data retransmissions based on the BLERs and CSI reported by the set of UEs 115. If the expected quantity of data retransmissions satisfies (e.g., meets or exceeds) a threshold, the network entity 105-b may switch to a cell discontinuous communication cycle having a longer active duration, a shorter inactive duration, or a combination thereof, for example, to reduce latency at which the data retransmissions may be performed. Alternatively, ff the expected quantity of data retransmissions fails to satisfy a threshold, the network entity 105-b may switch to a cell discontinuous communication cycle having a shorter active duration, a longer inactive duration, or a combination thereof, for example, to reduce power consumption.

In some examples, the trigger condition may include a low-power wake up reception (LP-WUR) capability of the set of UEs 115. For example, if a UE 115 supports LP-WUR, a UE 115 may receive a wakeup signal from the network entity 105-b prior to receiving information from the network entity 105-b. As such, the UE 115 may be relatively less sensitive to communication delay compared to a UE 115 that does not support LP-WUR. Accordingly, if the set of UEs 115 support LP-WUR, the network entity 105-b may switch to a cell discontinuous communication cycle having a shorter active duration, a longer inactive duration, or a combination thereof, to support reduced power consumption.

In some examples, the trigger condition may be reception of a set of indications from the set of UEs 115 to switch to the second discontinuous communication cycle. For example, the network entity 105-b may switch to the second discontinuous communication cycle based on receiving a threshold quantity of indications from the set of UEs 115 to switch to the second discontinuous communication cycle.

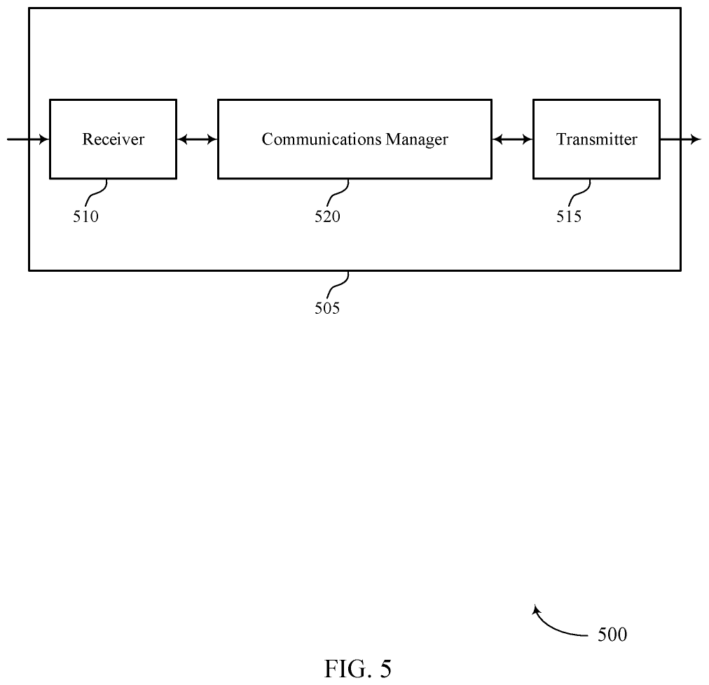

FIG. 5 shows a block diagram 500 of a device 505 that supports discontinuous communication cycle configuration switching in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to discontinuous communication cycle configuration switching). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to discontinuous communication cycle configuration switching). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of discontinuous communication cycle configuration switching as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle. The communications manager 520 is capable of, configured to, or operable to support a means for communicating according to a first discontinuous communication cycle of the first type or the second type in accordance with a first set of parameters of the set of multiple sets of parameters. The communications manager 520 is capable of, configured to, or operable to support a means for communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

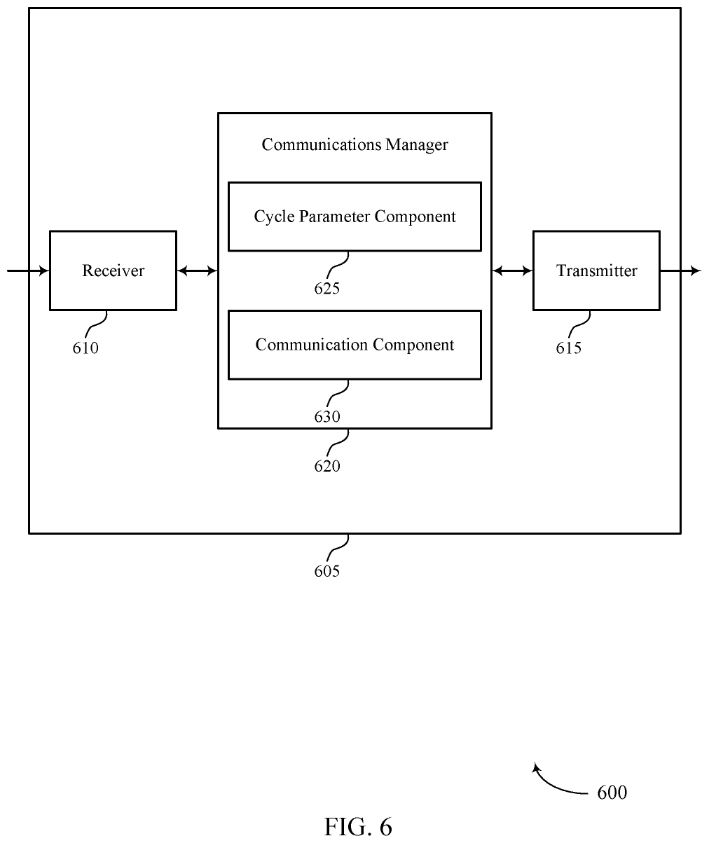

FIG. 6 shows a block diagram 600 of a device 605 that supports discontinuous communication cycle configuration switching in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to discontinuous communication cycle configuration switching). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to discontinuous communication cycle configuration switching). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of discontinuous communication cycle configuration switching as described herein. For example, the communications manager 620 may include a cycle parameter component 625 a communication component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The cycle parameter component 625 is capable of, configured to, or operable to support a means for receiving control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle. The communication component 630 is capable of, configured to, or operable to support a means for communicating according to a first discontinuous communication cycle of the first type or the second type in accordance with a first set of parameters of the set of multiple sets of parameters. The communication component 630 is capable of, configured to, or operable to support a means for communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

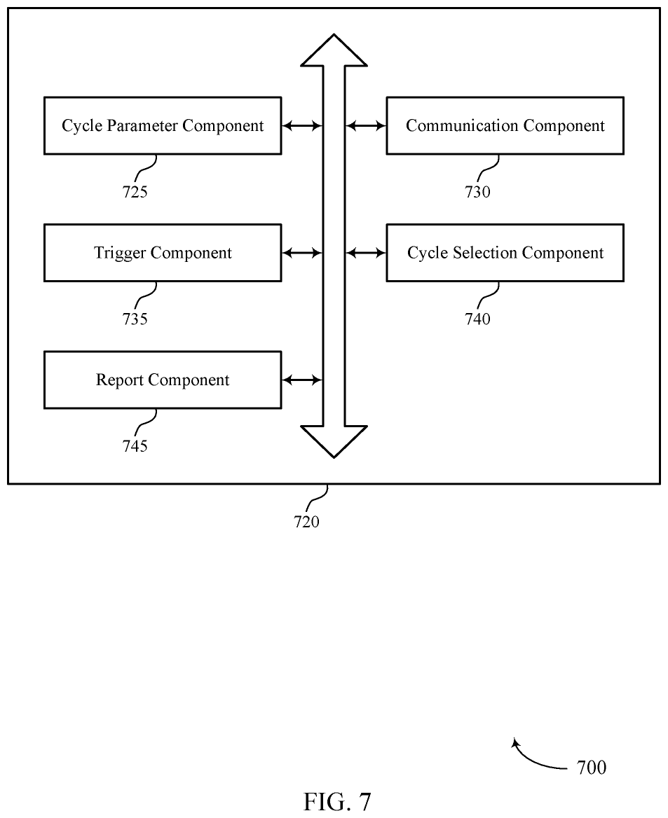

FIG. 7 shows a block diagram 700 of a communications manager 720 that supports discontinuous communication cycle configuration switching in accordance with one or more aspects of the present disclosure. The communications manager 720 may be an example of aspects of a communications manager 520, a communications manager 620, or both, as described herein. The communications manager 720, or various components thereof, may be an example of means for performing various aspects of discontinuous communication cycle configuration switching as described herein. For example, the communications manager 720 may include a cycle parameter component 725, a communication component 730, a trigger component 735, a cycle selection component 740, a report component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The cycle parameter component 725 is capable of, configured to, or operable to support a means for receiving control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle. The communication component 730 is capable of, configured to, or operable to support a means for communicating according to a first discontinuous communication cycle of the first type or the second type in accordance with a first set of parameters of the set of multiple sets of parameters. In some examples, the communication component 730 is capable of, configured to, or operable to support a means for communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

In some examples, the trigger component 735 is capable of, configured to, or operable to support a means for communicating an indication associated with switching between discontinuous communication cycles, where the trigger condition corresponds to the communication of the indication.

In some examples, the indication includes an indication from the UE to switch to the second discontinuous communication cycle, an indication from a network entity to switch to the second discontinuous communication cycle, an end of burst indication from the UE, an end of burst indication from the network entity, a PDCCH skipping indication from the network entity, a DRX MAC-CE, an indication of a change of traffic from the network entity, one or more scheduling requests from the UE, one or more NACKs from the UE, one or more NACKs from the network entity, a BSR, an indication of XR traffic, a DSR, a SDR, or an energy report.

In some examples, the switch to the second discontinuous communication cycle is based on a quantity of data associated with the BSR, an uplink packet data convergence protocol queueing delay associated with the DSR, an uplink packet data convergence protocol queueing delay associated with the SDR, a remaining packet delay budget indicated by the DSR for one or more LCHs or LCGs, a remaining packet delay budget indicated by the SDR for the one or more LCHs or LCGs, a charging rate indicated by the energy report, a discharging rate indicated by the energy report, an energy level associated with the UE indicated by the energy report, or an energy level prediction associated with the UE based on the energy report.

In some examples, the trigger component 735 is capable of, configured to, or operable to support a means for transmitting a request to switch from the first discontinuous communication cycle to the second discontinuous communication cycle, where the trigger condition corresponds to the transmission of the request.

In some examples, to support transmitting the request, the trigger component 735 is capable of, configured to, or operable to support a means for transmitting the request via UCI, a MAC-CE, RRC signaling, or a combination thereof.

In some examples, to support transmitting the request, the trigger component 735 is capable of, configured to, or operable to support a means for multiplexing the request with a message including a scheduling request, a HARQ message, an uplink reference signal, a BSR, a PHR, a CSI report, or a combination thereof. In some examples, to support transmitting the request, the trigger component 735 is capable of, configured to, or operable to support a means for transmitting the request multiplexed with the message.

In some examples, the request is communicated based on one or more communication conditions satisfying one or more thresholds, the one or more communication conditions including a buffer status associated with a BSR, a delay status associated with a DSR, an error status associated with an error status report, a traffic condition, or a combination thereof.

In some examples, the trigger component 735 is capable of, configured to, or operable to support a means for communicating an energy report indicating a first energy level associated with the UE or a second energy level associated with a network entity, where the trigger condition corresponds to the first energy level satisfying a first threshold or the second energy level satisfying a second threshold.

In some examples, the energy report is communicated based on the UE being in an idle mode or an inactive mode. In some examples, the second discontinuous communication cycle is associated with the idle mode of the UE or the inactive mode of the UE.

In some examples, the set of multiple sets of parameters includes a first set of multiple sets of parameters for the first type of discontinuous communication cycle and a second set of multiple sets of parameters for the second type of discontinuous communication cycle, and the cycle selection component 740 is capable of, configured to, or operable to support a means for selecting a pair of discontinuous communication cycles according to which to communicate including one discontinuous communication cycle having a first set of parameters from the first plurality and one discontinuous communication cycle having a second set of parameters from the second plurality, where the first discontinuous communication cycle and the second discontinuous communication cycle are included in the pair of discontinuous communication cycles.

In some examples, the report component 745 is capable of, configured to, or operable to support a means for communicating one or more reports indicating one or more communication conditions associated with the UE, where selecting the pair of discontinuous communication cycles is based on the one or more reports.

In some examples, each set of parameters of the plurality is indicated as a respective discontinuous communication cycle configuration.

In some examples, the set of multiple sets of parameters are for the first type of discontinuous communication cycle. In some examples, each set of parameters of the plurality are included in a same discontinuous communication cycle configuration of the first type.

In some examples, the set of multiple sets of parameters are for the second type of discontinuous communication cycle. In some examples, each set of parameters of the plurality are included in a same discontinuous communication cycle configuration of the second type.

In some examples, each set of parameters of the plurality includes a respective periodicity of a corresponding discontinuous communication cycle, a respective on duration of the corresponding discontinuous communication cycle, a respective off duration of the corresponding discontinuous communication cycle, a respective start offset of the corresponding discontinuous communication cycle, one or more respective timers of the corresponding discontinuous communication cycle including a respective inactivity timer, or a combination thereof.

In some examples, the first and second type of discontinuous communication cycles include a DRX cycle for the UE, a DTX cycle for the UE, a DRX cycle for a network entity, or a DTX cycle for the network entity.

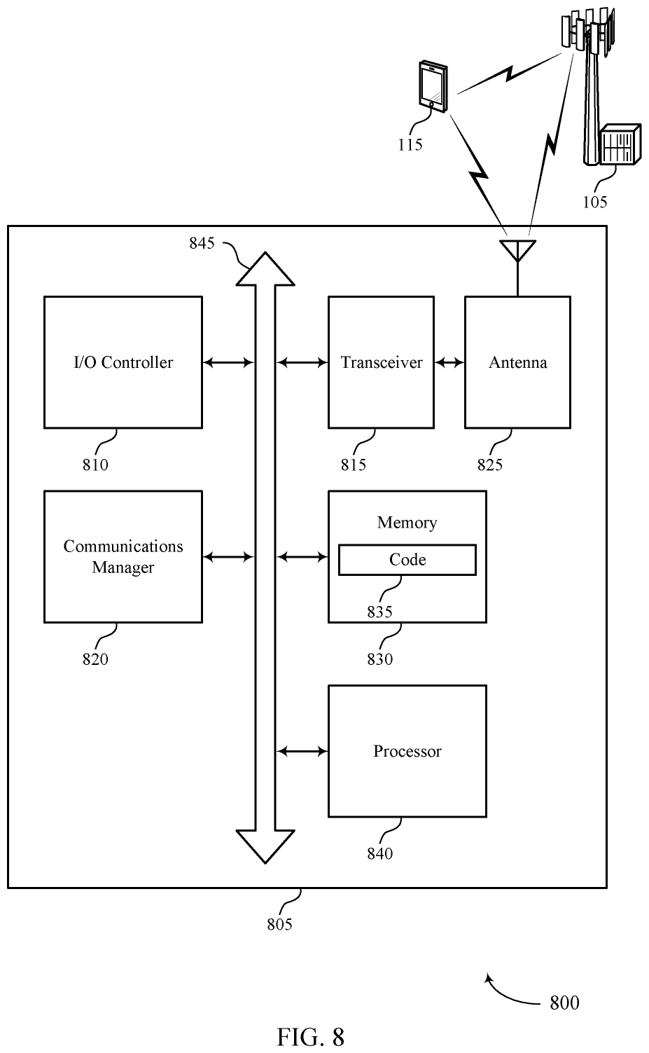

FIG. 8 shows a diagram of a system 800 including a device 805 that supports discontinuous communication cycle configuration switching in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting discontinuous communication cycle configuration switching). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein.

The communications manager 820 may support wireless communications in accordance with examples as disclosed herein. For example, the communications manager 820 is capable of, configured to, or operable to support a means for receiving control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle. The communications manager 820 is capable of, configured to, or operable to support a means for communicating according to a first discontinuous communication cycle of the first type or the second type in accordance with a first set of parameters of the set of multiple sets of parameters. The communications manager 820 is capable of, configured to, or operable to support a means for communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

By including or configuring the communications manager 820 in accordance with examples as described herein, the device 805 may support techniques for reduced latency, reduced power consumption, more efficient utilization of communication resources, improved coordination between devices, and longer battery life, among other benefits.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of discontinuous communication cycle configuration switching as described herein, or the at least one processor 840 and the at least one memory 830 may be otherwise configured to, individually or collectively, perform or support such operations.

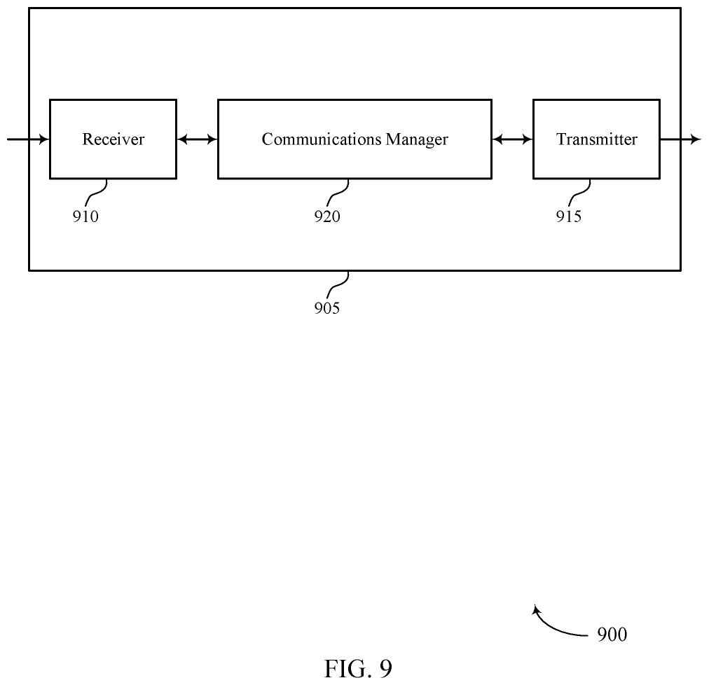

FIG. 9 shows a block diagram 900 of a device 905 that supports discontinuous communication cycle configuration switching in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of discontinuous communication cycle configuration switching as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting control signaling indicating respective parameters for a first type of discontinuous communication cycle and a second type of discontinuous communication cycle, where the control signaling indicates a set of multiple sets of parameters for at least one of the first type of discontinuous communication cycle or the second type discontinuous of communication cycle, and where the first type of discontinuous communication cycle corresponds to discontinuous communication cycles having a greater periodicity than discontinuous communication cycles of the second type of discontinuous communication cycle. The communications manager 920 is capable of, configured to, or operable to support a means for communicating according to a first discontinuous communication cycle of the first type or the second type in accordance with a first set of parameters of the set of multiple sets of parameters. The communications manager 920 is capable of, configured to, or operable to support a means for communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, more efficient utilization of communication resources.

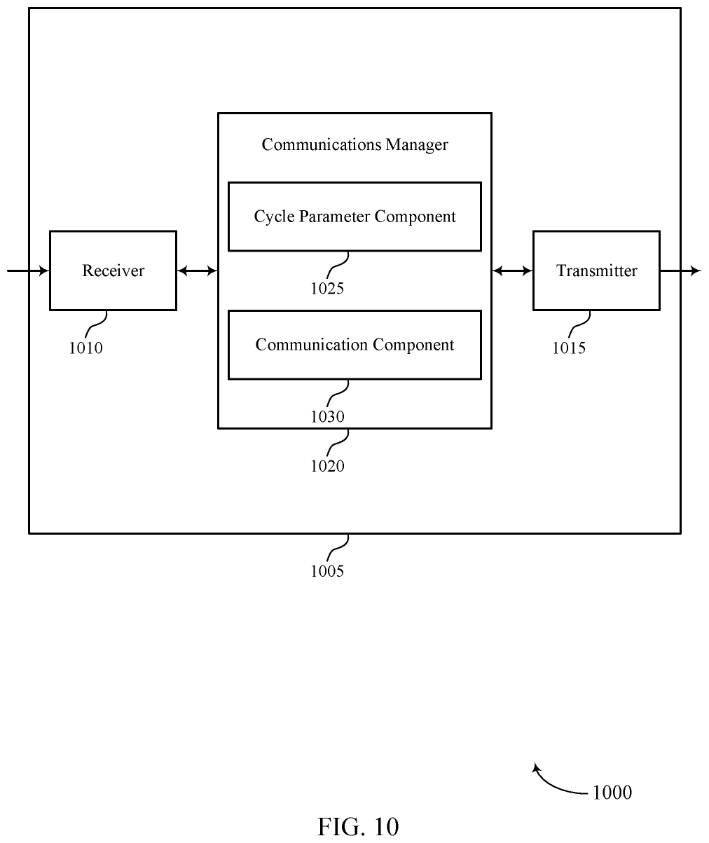

FIG. 10 shows a block diagram 1000 of a device 1005 that supports discontinuous communication cycle configuration switching in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of discontinuous communication cycle configuration switching as described herein. For example, the communications manager 1020 may include a cycle parameter component 1025 a communication component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The cycle parameter component 1025 is capable of, configured to, or operable to support a means for transmitting control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle. The communication component 1030 is capable of, configured to, or operable to support a means for communicating according to a first discontinuous communication cycle of the first type or the second type in accordance with a first set of parameters of the set of multiple sets of parameters. The communication component 1030 is capable of, configured to, or operable to support a means for communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

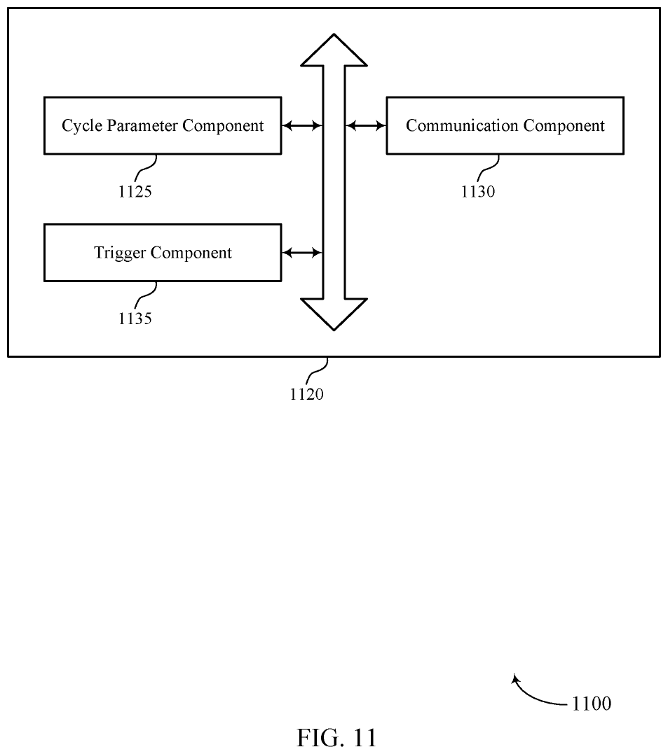

FIG. 11 shows a block diagram 1100 of a communications manager 1120 that supports discontinuous communication cycle configuration switching in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of discontinuous communication cycle configuration switching as described herein. For example, the communications manager 1120 may include a cycle parameter component 1125, a communication component 1130, a trigger component 1135, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a LCH of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The cycle parameter component 1125 is capable of, configured to, or operable to support a means for transmitting control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle. The communication component 1130 is capable of, configured to, or operable to support a means for communicating according to a first discontinuous communication cycle of the first type or the second type in accordance with a first set of parameters of the set of multiple sets of parameters. In some examples, the communication component 1130 is capable of, configured to, or operable to support a means for communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

In some examples, the trigger condition includes traffic associated with one or more UEs served by the network entity satisfying a threshold, a priority of the traffic satisfying a threshold priority, a QoS associated with the one or more UEs, one or more delay statuses associated with one or more DSRs from the one or more UEs, one or more energy levels associated with the one or more UEs, an expected quantity of data retransmissions based on one or more BLERs or one or more CSI reports from the one or more UEs, a LP-WUR capability of the one or more UEs, or a combination thereof.

In some examples, the trigger component 1135 is capable of, configured to, or operable to support a means for receiving a set of indications from a set of UEs to switch to the second discontinuous communication cycle, where the trigger condition corresponds to the reception of the set of indications.

In some examples, the trigger component 1135 is capable of, configured to, or operable to support a means for communicating an indication associated with switching between discontinuous communication cycles, where the trigger condition corresponds to the communication of the indication.

In some examples, the indication includes an indication from a UE to switch to the second discontinuous communication cycle, an indication from a network entity to switch to the second discontinuous communication cycle, an end of burst indication from the UE, an end of burst indication from the network entity, a PDCCH skipping indication from the network entity, a DRX MAC-CE, an indication of a change of traffic from the network entity, one or more scheduling requests from the UE, one or more NACKs from the UE, one or more NACKs from the network entity, a BSR, an indication of extended reality traffic, a DSR, a SDR, or an energy report.

In some examples, the switch to the second discontinuous communication cycle is based on a quantity of data associated with the BSR, an uplink packet data convergence protocol queueing delay associated with the DSR, an uplink packet data convergence protocol queueing delay associated with the SDR, a remaining packet delay budget indicated by the DSR for one or more LCHs or LCGs, a remaining packet delay budget indicated by the SDR for the one or more LCHs or LCGs, a charging rate indicated by the energy report, a discharging rate indicated by the energy report, an energy level associated with a UE indicated by the energy report, or an energy level prediction associated with the UE based on the energy report.

In some examples, the trigger component 1135 is capable of, configured to, or operable to support a means for receiving a request to switch from the first discontinuous communication cycle to the second discontinuous communication cycle, where the trigger condition corresponds to the reception of the request.

In some examples, the request is communicated based on one or more communication conditions satisfying one or more thresholds, the one or more communication conditions including a buffer status associated with a BSR, a delay status associated with a DSR, an error status associated with an error status report, a traffic condition, or a combination thereof.

In some examples, the trigger component 1135 is capable of, configured to, or operable to support a means for communicating an energy report indicating a first energy level associated with a UE or a second energy level associated with a network entity, where the trigger condition corresponds to the first energy level satisfying a first threshold or the second energy level satisfying a second threshold.

In some examples, each set of parameters of the plurality is indicated as a respective discontinuous communication cycle configuration. In some examples, each set of parameters of the plurality are included in a same discontinuous communication cycle configuration of the first type or the second type.

In some examples, the first and second type of discontinuous communication cycles include a DRX cycle for a UE, a DTX cycle for the UE, a DRX cycle for the network entity, or a DTX cycle for the network entity.

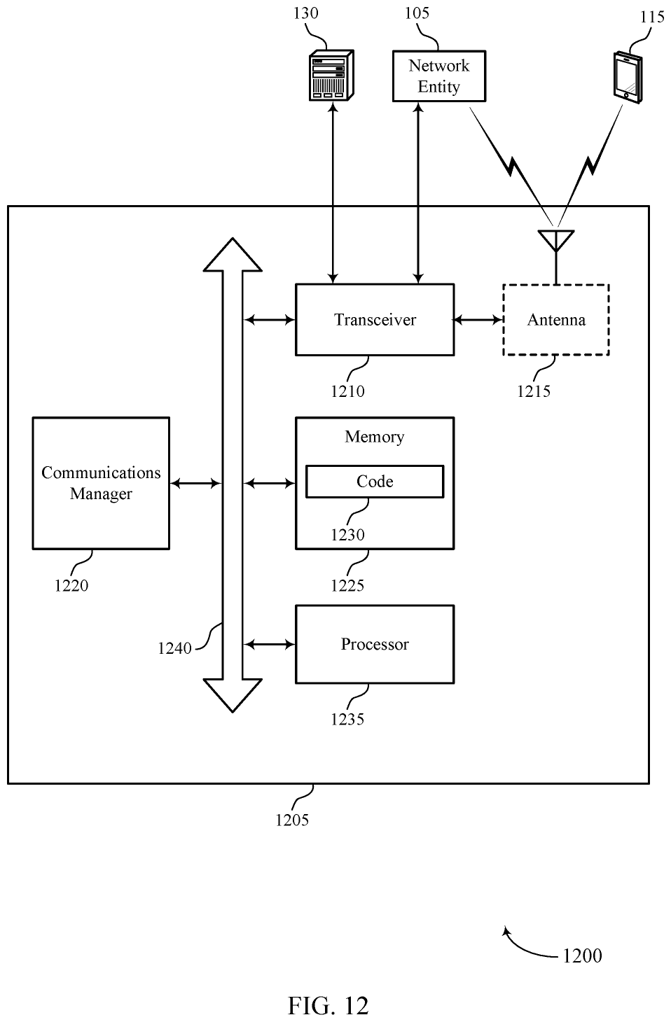

FIG. 12 shows a diagram of a system 1200 including a device 1205 that supports discontinuous communication cycle configuration switching in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting discontinuous communication cycle configuration switching). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some implementations, the at least one processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the at least one processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a LCH of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle. The communications manager 1220 is capable of, configured to, or operable to support a means for communicating according to a first discontinuous communication cycle of the first type or the second type in accordance with a first set of parameters of the set of multiple sets of parameters. The communications manager 1220 is capable of, configured to, or operable to support a means for communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition.

By including or configuring the communications manager 1220 in accordance with examples as described herein, the device 1205 may support techniques for reduced latency, reduced power consumption, more efficient utilization of communication resources, improved coordination between devices, and longer battery life, among other benefits.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of discontinuous communication cycle configuration switching as described herein, or the at least one processor 1235 and the at least one memory 1225 may be otherwise configured to, individually or collectively, perform or support such operations.

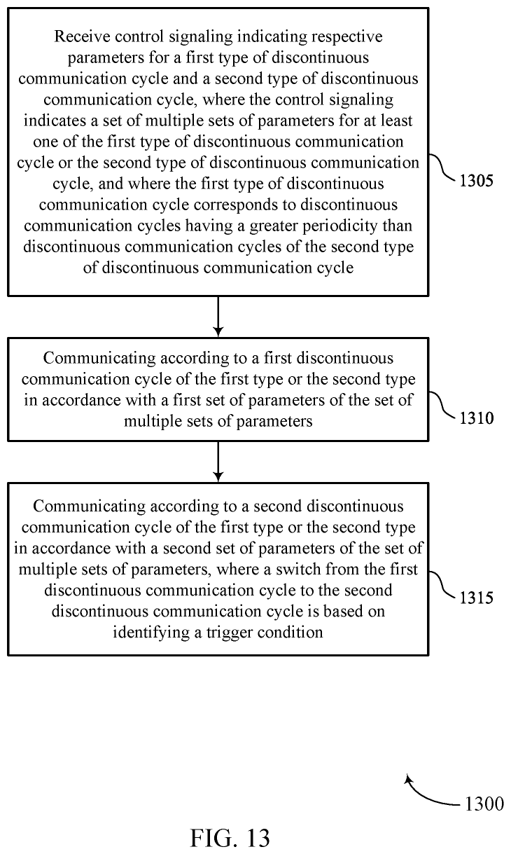

FIG. 13 shows a flowchart illustrating a method 1300 that supports discontinuous communication cycle configuration switching in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle. The operations of block 1305 may be performed in accordance with examples as disclosed herein. In some examples, aspects of the operations of 1305 may be performed by a cycle parameter component 725 as described with reference to FIG. 7.

At 1310, the method may include communicating according to a first discontinuous communication cycle of the first type or the second type in accordance with a first set of parameters of the set of multiple sets of parameters. The operations of block 1310 may be performed in accordance with examples as disclosed herein. In some examples, aspects of the operations of 1310 may be performed by a communication component 730 as described with reference to FIG. 7.

At 1315, the method may include communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition. The operations of block 1315 may be performed in accordance with examples as disclosed herein. In some examples, aspects of the operations of 1315 may be performed by a communication component 730 as described with reference to FIG. 7.

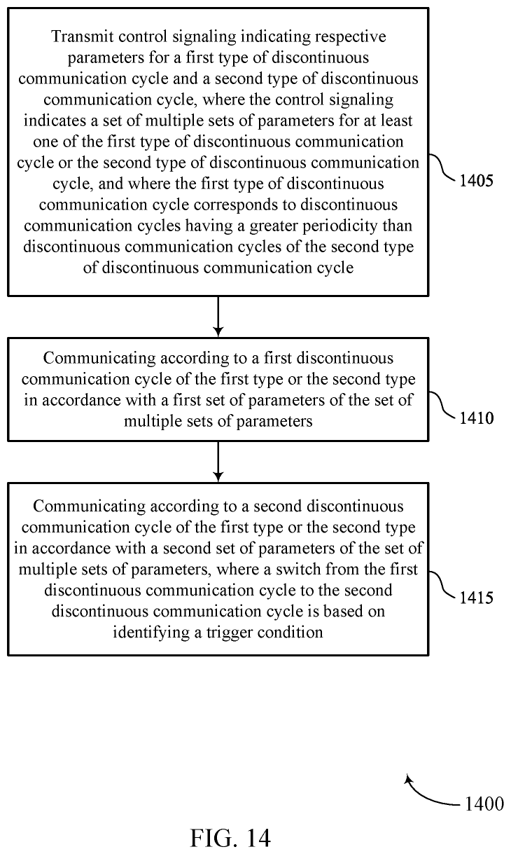

FIG. 14 shows a flowchart illustrating a method 1400 that supports discontinuous communication cycle configuration switching in accordance with aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting control signaling indicating respective parameters for a first type of discontinuous communication cycle and a second type of discontinuous communication cycle, where the control signaling indicates a set of multiple sets of parameters for at least one of the first type of discontinuous communication cycle or the second type of discontinuous communication cycle, and where the first type of discontinuous communication cycle corresponds to discontinuous communication cycles having a greater periodicity than discontinuous communication cycles of the second type of discontinuous communication cycle. The operations of block 1405 may be performed in accordance with examples as disclosed herein. In some examples, aspects of the operations of 1405 may be performed by a cycle parameter component 1125 as described with reference to FIG. 11.

At 1410, the method may include communicating according to a first discontinuous communication cycle of the first type or the second type in accordance with a first set of parameters of the set of multiple sets of parameters. The operations of block 1410 may be performed in accordance with examples as disclosed herein. In some examples, aspects of the operations of 1410 may be performed by a communication component 1130 as described with reference to FIG. 11.

At 1415, the method may include communicating according to a second discontinuous communication cycle of the first type or the second type in accordance with a second set of parameters of the set of multiple sets of parameters, where a switch from the first discontinuous communication cycle to the second discontinuous communication cycle is based on identifying a trigger condition. The operations of block 1415 may be performed in accordance with examples as disclosed herein. In some examples, aspects of the operations of 1415 may be performed by a communication component 1130 as described with reference to FIG. 11.

The following provides an overview of aspects of the present disclosure:

Aspect 1: A method for wireless communications at a UE, comprising: receiving control signaling indicating respective parameters for a first type of discontinuous communication cycle and a second type of discontinuous communication cycle, wherein the control signaling indicates a plurality of sets of parameters for at least one of the first type of discontinuous communication cycle or the second type of discontinuous communication cycle, and wherein the first type of discontinuous communication cycle corresponds to discontinuous communication cycles having a greater periodicity than discontinuous communication cycles of the second type of discontinuous communication cycle; communicating according to a first discontinuous communication cycle of the first type or the second type in accordance with a first set of parameters of the plurality of sets of parameters; and communicating according to a second discontinuous communication cycle of the first type or the second type in accordance with a second set of parameters of the plurality of sets of parameters, wherein a switch from the first discontinuous communication cycle to the second discontinuous communication cycle is based at least in part on identifying a trigger condition.

Aspect 2: The method of aspect 1, further comprising: communicating an indication associated with switching between discontinuous communication cycles, wherein the trigger condition corresponds to the communication of the indication.

Aspect 3: The method of aspect 2, wherein the indication comprises an indication from the UE to switch to the second discontinuous communication cycle, an indication from a network entity to switch to the second discontinuous communication cycle, an end of burst indication from the UE, an end of burst indication from the network entity, a PDCCH skipping indication from the network entity, a DRX MAC-CE, an indication of a change of traffic from the network entity, one or more scheduling requests from the UE, one or more NACKs from the UE, one or more NACKs from the network entity, a BSR, an indication of XR traffic, a DSR, a SDR, or an energy report.

Aspect 4: The method of aspect 3, wherein the switch to the second discontinuous communication cycle is based at least in part on a quantity of data associated with the BSR, an uplink packet data convergence protocol queueing delay associated with the DSR, an uplink packet data convergence protocol queueing delay associated with the SDR, a remaining packet delay budget indicated by the DSR for one or more LCHs or LCGs, a remaining packet delay budget indicated by the SDR for the one or more LCHs or LCGs, a charging rate indicated by the energy report, a discharging rate indicated by the energy report, an energy level associated with the UE indicated by the energy report, or an energy level prediction associated with the UE based on the energy report.

Aspect 5: The method of any of aspects 1 through 4, further comprising: transmitting a request to switch from the first discontinuous communication cycle to the second discontinuous communication cycle, wherein the trigger condition corresponds to the transmission of the request.

Aspect 6: The method of aspect 5, wherein transmitting the request comprises: transmitting the request via UCI, a MAC-CE, RRC signaling, or a combination thereof.

Aspect 7: The method of any of aspects 5 through 6, wherein transmitting the request comprises: multiplexing the request with a message comprising a scheduling request, a HARQ message, an uplink reference signal, a BSR, a PHR, a CSI report, or a combination thereof; and transmitting the request multiplexed with the message.

Aspect 8: The method of any of aspects 5 through 7, wherein the request is communicated based at least in part on one or more communication conditions satisfying one or more thresholds, the one or more communication conditions comprising a buffer status associated with a BSR, a delay status associated with a DSR, an error status associated with an error status report, a traffic condition, or a combination thereof.

Aspect 9: The method of any of aspects 1 through 8, further comprising: communicating an energy report indicating a first energy level associated with the UE or a second energy level associated with a network entity, wherein the trigger condition corresponds to the first energy level satisfying a first threshold or the second energy level satisfying a second threshold.

Aspect 10: The method of aspect 9, wherein the energy report is communicated based at least in part on the UE being in an idle mode or an inactive mode, and the second discontinuous communication cycle is associated with the idle mode of the UE or the inactive mode of the UE.

Aspect 11: The method of any of aspects 1 through 10, wherein the plurality of sets of parameters comprises a first plurality of sets of parameters for the first type of discontinuous communication cycle and a second plurality of sets of parameters for the second type of discontinuous communication cycle, the method further comprising: selecting a pair of discontinuous communication cycles according to which to communicate comprising one discontinuous communication cycle having a first set of parameters from the first plurality and one discontinuous communication cycle having a second set of parameters from the second plurality, wherein the first discontinuous communication cycle and the second discontinuous communication cycle are included in the pair of discontinuous communication cycles.

Aspect 12: The method of aspect 11, further comprising: communicating one or more reports indicating one or more communication conditions associated with the UE, wherein selecting the pair of discontinuous communication cycles is based at least in part on the one or more reports.

Aspect 13: The method of any of aspects 1 through 12, wherein each set of parameters of the plurality is indicated as a respective discontinuous communication cycle configuration.

Aspect 14: The method of any of aspects 1 through 12, wherein the plurality of sets of parameters are for the first type of discontinuous communication cycle, and each set of parameters of the plurality are included in a same discontinuous communication cycle configuration of the first type.

Aspect 15: The method of any of aspects 1 through 12, wherein the plurality of sets of parameters are for the second type of discontinuous communication cycle, and each set of parameters of the plurality are included in a same discontinuous communication cycle configuration of the second type.

Aspect 16: The method of any of aspects 1 through 15, wherein each set of parameters of the plurality comprises a respective periodicity of a corresponding discontinuous communication cycle, a respective on duration of the corresponding discontinuous communication cycle, a respective off duration of the corresponding discontinuous communication cycle, a respective start offset of the corresponding discontinuous communication cycle, one or more respective timers of the corresponding discontinuous communication cycle comprising a respective inactivity timer, or a combination thereof.

Aspect 17: The method of any of aspects 1 through 16, wherein the first and second type of discontinuous communication cycles comprise a DRX cycle for the UE, a DTX cycle for the UE, a DRX cycle for a network entity, or a DTX cycle for the network entity.

Aspect 18: A method for wireless communications at a network entity, comprising: transmitting control signaling indicating respective parameters for a first type of discontinuous communication cycle and a second type of discontinuous communication cycle, wherein the control signaling indicates a plurality of sets of parameters for at least one of the first type of discontinuous communication cycle or the second type discontinuous communication cycle, and wherein the first type of discontinuous communication cycle corresponds to discontinuous communication cycles having a greater periodicity than discontinuous communication cycles of the second type of discontinuous communication cycle; communicating according to a first discontinuous communication cycle of the first type or the second type in accordance with a first set of parameters of the plurality of sets of parameters; and communicating according to a second discontinuous communication cycle of the first type or the second type in accordance with a second set of parameters of the plurality of sets of parameters, wherein a switch from the first discontinuous communication cycle to the second discontinuous communication cycle is based at least in part on identifying a trigger condition.

Aspect 19: The method of aspect 18, wherein the trigger condition comprises traffic associated with one or more UEs served by the network entity satisfying a threshold, a priority of the traffic satisfying a threshold priority, a quality of service associated with the one or more UEs, one or more delay statuses associated with one or more DSRs from the one or more UEs, one or more energy levels associated with the one or more UEs, an expected quantity of data retransmissions based on one or more block error rates or one or more channel state information reports from the one or more UEs, a low-power wake up reception capability of the one or more UEs, or a combination thereof.

Aspect 20: The method of any of aspects 18 through 19, further comprising: receiving a set of indications from a set of UEs to switch to the second discontinuous communication cycle, wherein the trigger condition corresponds to the reception of the set of indications.

Aspect 21: The method of any of aspects 18 through 20, further comprising: communicating an indication associated with switching between discontinuous communication cycles, wherein the trigger condition corresponds to the communication of the indication.

Aspect 22: The method of aspect 21, wherein the indication comprises an indication from a UE to switch to the second discontinuous communication cycle, an indication from a network entity to switch to the second discontinuous communication cycle, an end of burst indication from the UE, an end of burst indication from the network entity, a PDCCH skipping indication from the network entity, a DRX MAC-CE, an indication of a change of traffic from the network entity, one or more scheduling requests from the UE, one or more NACKs from the UE, one or more NACKs from the network entity, a BSR, an indication of XR traffic, a DSR, a SDR, or an energy report.

Aspect 23: The method of aspect 22, wherein the switch to the second discontinuous communication cycle is based at least in part on a quantity of data associated with the BSR, an uplink packet data convergence protocol queueing delay associated with the DSR, an uplink packet data convergence protocol queueing delay associated with the SDR, a remaining packet delay budget indicated by the DSR for one or more LCHs or LCGs, a remaining packet delay budget indicated by the SDR for the one or more LCHs or LCGs, a charging rate indicated by the energy report, a discharging rate indicated by the energy report, an energy level associated with a UE indicated by the energy report, or an energy level prediction associated with the UE based on the energy report.

Aspect 24: The method of any of aspects 18 through 23, further comprising: receiving a request to switch from the first discontinuous communication cycle to the second discontinuous communication cycle, wherein the trigger condition corresponds to the reception of the request.

Aspect 25: The method of aspect 24, wherein the request is communicated based at least in part on one or more communication conditions satisfying one or more thresholds, the one or more communication conditions comprising a buffer status associated with a BSR, a delay status associated with a DSR, an error status associated with an error status report, a traffic condition, or a combination thereof.

Aspect 26: The method of any of aspects 18 through 25, further comprising: communicating an energy report indicating a first energy level associated with a UE or a second energy level associated with a network entity, wherein the trigger condition corresponds to the first energy level satisfying a first threshold or the second energy level satisfying a second threshold.

Aspect 27: The method of any of aspects 18 through 26, wherein each set of parameters of the plurality is indicated as a respective discontinuous communication cycle configuration, or each set of parameters of the plurality are included in a same discontinuous communication cycle configuration of the first type or the second type.

Aspect 28: The method of any of aspects 18 through 27, wherein the first and second type of discontinuous communication cycles comprise a DRX cycle for a UE, a DTX cycle for the UE, a DRX cycle for the network entity, or a DTX cycle for the network entity.

Aspect 29: A UE for wireless communications, comprising one or more memories storing processor-executable code, and one or more processors coupled with the one or more memories and individually or collectively operable to execute the code to cause the UE to perform a method of any of aspects 1 through 17.

Aspect 30: A UE for wireless communications, comprising at least one means for performing a method of any of aspects 1 through 17.

Aspect 31: A non-transitory computer-readable medium storing code for wireless communications, the code comprising instructions executable by a processor to perform a method of any of aspects 1 through 17.

Aspect 32: A network entity for wireless communications, comprising one or more memories storing processor-executable code, and one or more processors coupled with the one or more memories and individually or collectively operable to execute the code to cause the network entity to perform a method of any of aspects 18 through 28.

Aspect 33: A network entity for wireless communications, comprising at least one means for performing a method of any of aspects 18 through 28.

Aspect 34: A non-transitory computer-readable medium storing code for wireless communications, the code comprising instructions executable by a processor to perform a method of any of aspects 18 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicating respective parameters for a first type of discontinuous communication cycle and a second type of discontinuous communication cycle, wherein the control signaling indicates a plurality of sets of parameters for at least one of the first type of discontinuous communication cycle or the second type of discontinuous communication cycle, and wherein the first type of discontinuous communication cycle corresponds to discontinuous communication cycles having a greater periodicity than discontinuous communication cycles of the second type of discontinuous communication cycle;
communicating according to a first discontinuous communication cycle of the first type or the second type in accordance with a first set of parameters of the plurality of sets of parameters; and
communicating according to a second discontinuous communication cycle of the first type or the second type in accordance with a second set of parameters of the plurality of sets of parameters, wherein a switch from the first discontinuous communication cycle to the second discontinuous communication cycle is based at least in part on identifying a trigger condition.

2. The UE of claim 1, wherein the one or more processors are individually or collectively further operable to execute the code to cause the UE to:
communicate an indication associated with switching between discontinuous communication cycles, wherein the trigger condition corresponds to the communication of the indication.

3. The UE of claim 2, wherein the indication comprises an indication from the UE to switch to the second discontinuous communication cycle, an indication from a network entity to switch to the second discontinuous communication cycle, an end of burst indication from the UE, an end of burst indication from the network entity, a physical downlink control channel skipping indication from the network entity, a discontinuous reception medium access control-control element, an indication of a change of traffic from the network entity, one or more scheduling requests from the UE, one or more negative acknowledgements from the UE, one or more negative acknowledgements from the network entity, a buffer status report, an indication of extended reality traffic, a delay status report, a statistical delay report, or an energy report.

4. The UE of claim 3, wherein the switch to the second discontinuous communication cycle is based at least in part on a quantity of data associated with the buffer status report, an uplink packet data convergence protocol queueing delay associated with the delay status report, an uplink packet data convergence protocol queueing delay associated with the statistical delay report, a remaining packet delay budget indicated by the delay status report for one or more logical channels or logical channel groups, a remaining packet delay budget indicated by the statistical delay report for the one or more logical channels or logical channel groups, a charging rate indicated by the energy report, a discharging rate indicated by the energy report, an energy level associated with the UE indicated by the energy report, or an energy level prediction associated with the UE based on the energy report.

5. The UE of claim 1, wherein the one or more processors are individually or collectively further operable to execute the code to cause the UE to:
transmit a request to switch from the first discontinuous communication cycle to the second discontinuous communication cycle, wherein the trigger condition corresponds to the transmission of the request.

6. The UE of claim 5, wherein, to transmit the request, the one or more processors are individually or collectively operable to execute the code to cause the UE to:
transmit the request via uplink control information, a medium access control-control element, radio resource control signaling, or a combination thereof.

7. The UE of claim 5, wherein, to transmit the request, the one or more processors are individually or collectively operable to execute the code to cause the UE to:
multiplex the request with a message comprising a scheduling request, a hybrid automatic repeat request message, an uplink reference signal, a buffer status report, a power headroom report, a channel state information report, or a combination thereof; and
transmit the request multiplexed with the message.

8. The UE of claim 5, wherein the request is communicated based at least in part on one or more communication conditions satisfying one or more thresholds, the one or more communication conditions comprising a buffer status associated with a buffer status report, a delay status associated with a delay status report, an error status associated with an error status report, a traffic condition, or a combination thereof.

9. The UE of claim 1, wherein the one or more processors are individually or collectively further operable to execute the code to cause the UE to:
communicate an energy report indicating a first energy level associated with the UE or a second energy level associated with a network entity, wherein the trigger condition corresponds to the first energy level satisfying a first threshold or the second energy level satisfying a second threshold.

10. The UE of claim 9, wherein:
the energy report is communicated based at least in part on the UE being in an idle mode or an inactive mode, and
the second discontinuous communication cycle is associated with the idle mode of the UE or the inactive mode of the UE.

11. The UE of claim 1, wherein the plurality of sets of parameters comprises a first plurality of sets of parameters for the first type of discontinuous communication cycle and a second plurality of sets of parameters for the second type of discontinuous communication cycle, and wherein the one or more processors are individually or collectively further operable to execute the code to cause the UE to:
select a pair of discontinuous communication cycles according to which to communicate comprising one discontinuous communication cycle having a first set of parameters from the first plurality and one discontinuous communication cycle having a second set of parameters from the second plurality,
wherein the first discontinuous communication cycle and the second discontinuous communication cycle are included in the pair of discontinuous communication cycles.

12. The UE of claim 11, wherein the one or more processors are individually or collectively further operable to execute the code to cause the UE to:
communicate one or more reports indicating one or more communication conditions associated with the UE, wherein selecting the pair of discontinuous communication cycles is based at least in part on the one or more reports.

13. The UE of claim 1, wherein each set of parameters of the plurality is indicated as a respective discontinuous communication cycle configuration.

14. The UE of claim 1, wherein:
the plurality of sets of parameters are for the first type of discontinuous communication cycle, and
each set of parameters of the plurality are included in a same discontinuous communication cycle configuration of the first type.

15. The UE of claim 1, wherein:
the plurality of sets of parameters are for the second type of discontinuous communication cycle, and
each set of parameters of the plurality are included in a same discontinuous communication cycle configuration of the second type.

16. The UE of claim 1, wherein each set of parameters of the plurality comprises a respective periodicity of a corresponding discontinuous communication cycle, a respective on duration of the corresponding discontinuous communication cycle, a respective off duration of the corresponding discontinuous communication cycle, a respective start offset of the corresponding discontinuous communication cycle, one or more respective timers of the corresponding discontinuous communication cycle comprising a respective inactivity timer, or a combination thereof.

17. The UE of claim 1, wherein the first and second type of discontinuous communication cycles comprise a discontinuous reception cycle for the UE, a discontinuous transmission cycle for the UE, a discontinuous reception cycle for a network entity, or a discontinuous transmission cycle for the network entity.

18. A network entity, comprising:
one or more memories storing processor-executable code; and
one or more processors coupled with the one or more memories and individually or collectively operable to execute the code to cause the network entity to:
transmit control signaling indicating respective parameters for a first type of discontinuous communication cycle and a second type of discontinuous communication cycle, wherein the control signaling indicates a plurality of sets of parameters for at least one of the first type of discontinuous communication cycle or the second type of discontinuous communication cycle, and wherein the first type of discontinuous communication cycle corresponds to discontinuous communication cycles having a greater periodicity than discontinuous communication cycles of the second type of discontinuous communication cycle;
communicating according to a first discontinuous communication cycle of the first type or the second type in accordance with a first set of parameters of the plurality of sets of parameters; and
communicating according to a second discontinuous communication cycle of the first type or the second type in accordance with a second set of parameters of the plurality of sets of parameters, wherein a switch from the first discontinuous communication cycle to the second discontinuous communication cycle is based at least in part on identifying a trigger condition.

19. The network entity of claim 18, wherein the trigger condition comprises traffic associated with one or more user equipment (UEs) served by the network entity satisfying a threshold, a priority of the traffic satisfying a threshold priority, a quality of service associated with the one or more UEs, one or more delay statuses associated with one or more delay status reports from the one or more UEs, one or more energy levels associated with the one or more UEs, an expected quantity of data retransmissions based on one or more block error rates or one or more channel state information reports from the one or more UEs, a low-power wake up reception capability of the one or more UEs, or a combination thereof.

20. The network entity of claim 18, wherein the one or more processors are individually or collectively further operable to execute the code to cause the network entity to:
receive a set of indications from a set of user equipment (UEs) to switch to the second discontinuous communication cycle, wherein the trigger condition corresponds to the reception of the set of indications.

21. The network entity of claim 18, wherein the one or more processors are individually or collectively further operable to execute the code to cause the network entity to:
communicate an indication associated with switching between discontinuous communication cycles, wherein the trigger condition corresponds to the communication of the indication.

22. The network entity of claim 21, wherein the indication comprises an indication from a user equipment (UE) to switch to the second discontinuous communication cycle, an indication from a network entity to switch to the second discontinuous communication cycle, an end of burst indication from the UE, an end of burst indication from the network entity, a physical downlink control channel skipping indication from the network entity, a discontinuous reception medium access control-control element, an indication of a change of traffic from the network entity, one or more scheduling requests from the UE, one or more negative acknowledgements from the UE, one or more negative acknowledgements from the network entity, a buffer status report, an indication of extended reality traffic, a delay status report, a statistical delay report, or an energy report.

23. The network entity of claim 22, wherein the switch to the second discontinuous communication cycle is based at least in part on a quantity of data associated with the buffer status report, an uplink packet data convergence protocol queueing delay associated with the delay status report, an uplink packet data convergence protocol queueing delay associated with the statistical delay report, a remaining packet delay budget indicated by the delay status report for one or more logical channels or logical channel groups, a remaining packet delay budget indicated by the statistical delay report for the one or more logical channels or logical channel groups, a charging rate indicated by the energy report, a discharging rate indicated by the energy report, an energy level associated with a user equipment (UE) indicated by the energy report, or an energy level prediction associated with the UE based on the energy report.

24. The network entity of claim 18, wherein the one or more processors are individually or collectively further operable to execute the code to cause the network entity to:
receive a request to switch from the first discontinuous communication cycle to the second discontinuous communication cycle, wherein the trigger condition corresponds to the reception of the request.

25. The network entity of claim 24, wherein the request is communicated based at least in part on one or more communication conditions satisfying one or more thresholds, the one or more communication conditions comprising a buffer status associated with a buffer status report, a delay status associated with a delay status report, an error status associated with an error status report, a traffic condition, or a combination thereof.

26. The network entity of claim 18, wherein the one or more processors are individually or collectively further operable to execute the code to cause the network entity to:
communicate an energy report indicating a first energy level associated with a user equipment (UE) or a second energy level associated with a network entity, wherein the trigger condition corresponds to the first energy level satisfying a first threshold or the second energy level satisfying a second threshold.

27. The network entity of claim 18, wherein:
each set of parameters of the plurality is indicated as a respective discontinuous communication cycle configuration, or
each set of parameters of the plurality are included in a same discontinuous communication cycle configuration of the first type or the second type.

28. The network entity of claim 18, wherein the first and second type of discontinuous communication cycles comprise a discontinuous reception cycle for a user equipment (UE), a discontinuous transmission cycle for the UE, a discontinuous reception cycle for the network entity, or a discontinuous transmission cycle for the network entity.

29. A method for wireless communications at a user equipment (UE), comprising:
receiving control signaling indicating respective parameters for a first type of discontinuous communication cycle and a second type of discontinuous communication cycle, wherein the control signaling indicates a plurality of sets of parameters for at least one of the first type of discontinuous communication cycle or the second type of discontinuous communication cycle, and wherein the first type of discontinuous communication cycle corresponds to discontinuous communication cycles having a greater periodicity than discontinuous communication cycles of the second type of discontinuous communication cycle;
communicating according to a first discontinuous communication cycle of the first type or the second type in accordance with a first set of parameters of the plurality of sets of parameters; and
communicating according to a second discontinuous communication cycle of the first type or the second type in accordance with a second set of parameters of the plurality of sets of parameters, wherein a switch from the first discontinuous communication cycle to the second discontinuous communication cycle is based at least in part on identifying a trigger condition.

30. A method for wireless communications at a network entity, comprising:
transmitting control signaling indicating respective parameters for a first type of discontinuous communication cycle and a second type of discontinuous communication cycle, wherein the control signaling indicates a plurality of sets of parameters for at least one of the first type of discontinuous communication cycle or the second type of discontinuous communication cycle, and wherein the first type of discontinuous communication cycle corresponds to discontinuous communication cycles having a greater periodicity than discontinuous communication cycles of the second type of discontinuous communication cycle;
communicating according to a first discontinuous communication cycle of the first type or the second type in accordance with a first set of parameters of the plurality of sets of parameters; and
communicating according to a second discontinuous communication cycle of the first type or the second type in accordance with a second set of parameters of the plurality of sets of parameters, wherein a switch from the first discontinuous communication cycle to the second discontinuous communication cycle is based at least in part on identifying a trigger condition.
